(19) United States
(12) Patent Application Publication
(10) Pub. No.: US 2021/0150953 A1
(43) Pub. Date: May 20, 2021

(54) METHOD AND DEVICE FOR PROVIDING USER INTERFACE IN ELECTRONIC DEVICE HAVING FOLDABLE DISPLAY

(71) Applicant: Samsung Electronics Co., Ltd., Gyeonggi-do (KR)

(72) Inventors: Jangwoo LEE, Gyeonggi-do (KR); Jaok KOO, Gyeonggi-do (KR); Suhyun NA, Gyeonggi-do (KR); Haneul LEE, Gyeonggi-do (KR); Soonchun JOUNG, Gyeonggi-do (KR); Sunmi JIN, Gyeonggi-do (KR)

(73) Assignee: Samsung Electronics Co., Ltd.

(21) Appl. No.: 16/950,252

(22) Filed: Nov. 17, 2020

(30) Foreign Application Priority Data
Nov. 19, 2019 (KR) 10-2019-0148394

(51) Int. Cl. G09G 3/00; G09G 5/38; G09G 5/14

(52) U.S. Cl. CPC G09G 3/035; G09G 5/38; G09G 2340/0464; G09G 2380/02; G09G 2354/00; G09G 5/14

(57) ABSTRACT

An electronic device including a foldable display and a method of operating the same are provided. The electronic device includes a display, a processor, and a memory. The memory may store instructions that, when executed, cause the processor to display one or more objects through the display, detect an operation event in which the display is switched from a first state to a second state, monitor a state change of the display based on the operation event, detect the display being folded to a designated angle, divide the display into a first display surface and a second display surface based on the display being folded to the designated angle, and rearrange and display the one or more objects based on at least one of the first display surface or the second display surface.

### CROSS-REFERENCE TO RELATED APPLICATION(S)

This application is based on and claims priority under 35 U.S.C. § 119 to Korean Patent Application No. 10-2019-0148394, which was filed in the Korean Intellectual Property Office on Nov. 19, 2019, the entire disclosure of which is incorporated herein by reference.

### BACKGROUND

### 1. Field

The disclosure relates generally to an electronic device having a foldable display (or a flexible display) and a method of operating the same.

### 2. Description of Related Art

Various types of electronic devices, such as mobile communication terminals, smart phones, tablet personal computers (PCs), notebook computers, or wearable devices, are widely used.

An electronic device may have a limited size for portability, and thus the size of a display is also limited. In recent years, various types of electronic devices have been developed with an expanded screen using a multi-display. For example, a plurality of displays are provided to provide an expanded screen by a multi-display. As another example, electronic devices are designed such that the sizes of screens gradually increase in the displays, and such that various services are provided to users through larger screens.

An electronic device may have a new form factor, such as a multi-display (e.g., a dual-display) device (e.g., a foldable device). The foldable device may be equipped with a foldable (or flexible) display so that the foldable device can be used while folded or unfolded.

According to the implementation of a multi-display, there is a need to develop a user interface (UI) corresponding to the multi-display and the operation thereof.

### SUMMARY

The disclosure has been made to address the above-mentioned problems and disadvantages, and to provide at least the advantages described below.

An aspect of the disclosure is to provide a method and device capable of freely adjusting a software window size and providing optimal screen division based on a physical characteristic that makes an electronic device foldable.

Another aspect of the disclosure is to provide a method and device capable of providing a UI in response to a change in the shape of a display.

Another aspect of the disclosure is to provide a method and device for operating a display in an electronic device (e.g., a foldable device) having at least two display surfaces.

Another aspect of the disclosure is to provide a method and device for adaptively operating a display to correspond to a folded state or an unfolded state in an electronic device including a first display surface and a second display surface.

Another aspect of the disclosure is to provide a method and device capable of dividing, in an electronic device including a foldable display, the display region of the foldable display based on an operation event (or trigger), in which the electronic device is unfolded or folded in a designated range, and capable of rearranging (relocating) UIs according to the divided regions.

Another aspect of the disclosure is to provide a method and device capable of automatically adjusting and providing, in an electronic device including a foldable display, the position and/or the size of an object (e.g., a window, a pop-up window, an icon, or a widget) depending on the position where the foldable display is folded.

In accordance with an aspect of the disclosure, an electronic device is provided, which includes a display, a processor operatively connected to the display, and memory operatively connected to the processor. The memory may store instructions that cause, when executed, the processor to: display one or more objects through the display; detect an operation event in which the display is switched from a first state to a second state; monitor a state change of the display based on the operation event; detect a state in which the display is folded to a designated angle; divide the display into a first display surface and a second display surface based on the state of being folded to the designated angle; and rearrange and display the one or more objects based on at least the first display surface or the second display surface.

In accordance with another aspect of the disclosure, an electronic device is provided, which includes a foldable display, a processor operatively connected to the foldable display, and memory operatively connected to the processor. The memory may be configured to store instructions that cause, when executed, the processor to: detect an operation event in which a state of the foldable display is changed; monitor a state change of the foldable display based on the operation event; display at least one object including an object included in a target region for a first state in a range greater than or equal to a designated range, and rearrange and display a remaining object in a main region when there is a first state change; and restore at least one object including an object included in a target region for a second state based on state information, and rearrange and display the at least one object through the target region and the main region when there is a second state change.

In accordance with another aspect of the disclosure, a method is provided for operating an electronic device. The method includes displaying one or more objects through a display; detecting an operation event in which the display is switched from a first state to a second state; monitoring a state change of the display based on the operation event; detecting a state in which the display is folded to a designated angle; dividing the display into a first display surface and a second display surface based on the state of being folded to the designated angle; and rearranging and displaying the one or more objects based on at least the first display surface or the second display surface.

### BRIEF DESCRIPTION THE DRAWINGS

The above and other aspects, features, and advantages of certain embodiments of the disclosure will be more apparent from the following description taken in conjunction with the accompanying drawings, in which:

FIG. 1 illustrates an electronic device in a network environment according to an embodiment;

FIG. 2 illustrates a display device according to an embodiment;

FIG. 3 illustrates an electronic device according to an embodiment;

FIG. 4 illustrates an electronic device according to an embodiment;

FIG. 5 illustrates an electronic device according to an embodiment;

FIG. 6 illustrates an electronic device according to an embodiment;

FIG. 7 illustrates an electronic device according to an embodiment;

FIG. 8 illustrates an operation of a display based on a state of a display in an electronic device according to an embodiment;

FIG. 9 is a flowchart illustrating a method of operating a display in an electronic device according to an embodiment;

FIG. 10 illustrates an operation of a display in an electronic device according to an embodiment;

FIG. 11 illustrates an operation of a display in an electronic device according to an embodiment;

FIG. 12 illustrates an operation of a display in an electronic device according to an embodiment;

FIG. 13 is a flowchart illustrating a method of operating an electronic device according to an embodiment;

FIG. 14 illustrates screen division in an electronic device according to an embodiment;

FIG. 15 is a flowchart illustrating a method of operating an electronic device according to an embodiment;

FIG. 16 illustrates screen division in an electronic device according to an embodiment;

FIG. 17 illustrates screen division in an electronic device according to an embodiment;

FIG. 18 is a flowchart illustrating a method of operating an electronic device according to an embodiment;

FIG. 19 is a flowchart illustrating method of operating an electronic device according to an embodiment;

FIG. 20 illustrates a visual guide in an electronic device according to an embodiment;

FIG. 21 illustrates a visual guide in an electronic device according to an embodiment;

FIG. 22 illustrates a visual guide in an electronic device according to an embodiment;

FIG. 23 illustrates a visual guide in an electronic device according to an embodiment;

FIG. 24 illustrates a visual guide in an electronic device according to an embodiment;

FIG. 25 illustrates a visual guide in an electronic device according to an embodiment;

FIG. 26 illustrates a visual guide in an electronic device according to an embodiment;

FIG. 27 illustrates a visual guide in an electronic device according to an embodiment;

FIG. 28 illustrates canceling screen division in an electronic device according to an embodiment;

FIG. 29 is a flowchart illustrating a method of operating an electronic device according to an embodiment;

FIG. 30 illustrates an operation of a display in an electronic device according to an embodiment;

FIG. 31 illustrates an operation of a display in an electronic device according to an embodiment;

FIG. 32 illustrates an operation of a display in an electronic device according to an embodiment;

FIG. 33 is a flowchart illustrating a method of operating an electronic device according to an embodiment;

FIG. 34 illustrates a visual guide in an electronic device according to an embodiment;

FIG. 35 illustrates a visual guide in an electronic device according to an embodiment;

FIG. 36 illustrates a visual guide in an electronic device according to an embodiment;

FIG. 37 illustrates a visual guide in an electronic device according to an embodiment;

FIG. 38 illustrates a visual guide in an electronic device according to an embodiment;

FIG. 39 illustrates a visual guide in an electronic device according to an embodiment;

FIG. 40 illustrates a visual guide in an electronic device according to an embodiment;

FIG. 41 illustrates a visual guide in an electronic device according to an embodiment; and

FIG. 42 illustrates canceling screen division in an electronic device according to an embodiment.

### DETAILED DESCRIPTION

Various embodiments of the disclosure will now be described in detail with reference to the accompanying drawings. In the following description, specific details such as detailed configuration and components are merely provided to assist the overall understanding of these embodiments of the disclosure. Therefore, it should be apparent to those skilled in the art that various changes and modifications of the embodiments described herein can be made without departing from the scope and spirit of the disclosure. In addition, descriptions of well-known functions and constructions are omitted for clarity and conciseness.

An electronic device according to an embodiment and a method of operating the same automatically adjust and provide a UI including at least one object to correspond to a change in a display shape (e.g., a change between a folded shape and an unfolded shape). When a display is unfolded, it is possible to provide a UI through the entire display surface (or region) of the display, and when the display is folded, it is possible to provide UIs divided according to at least two divided display surfaces.

According to an embodiment, in an electronic device including a first display surface and a second display surface, it is possible to adaptively operate the display to correspond to a folded state or an unfolded state.

According to an embodiment, it is possible to divide a screen and to automatically provide UIs corresponding to the screen division by changing the shape of the display (e.g., a physical gesture of folding the electronic device) without a cumbersome process of setting the electronic device through a separate setting process in order for the user to use the electronic device through screen division.

According to an embodiment, in an electronic device including a foldable display, it is possible to provide a method and device capable of dividing a display region of a foldable display based on an operation event (or trigger) in which the electronic device is unfolded or folded in a designated range and capable of rearranging (relocating) UIs according to the divided regions. It is also possible to automatically adjust the position and/or the size of an object (e.g., a window, a pop-up window, an icon, or a widget) and provide the same according to the position where the foldable display is folded. Accordingly, it is possible to improve usability; convenience, and competitiveness of the electronic device.

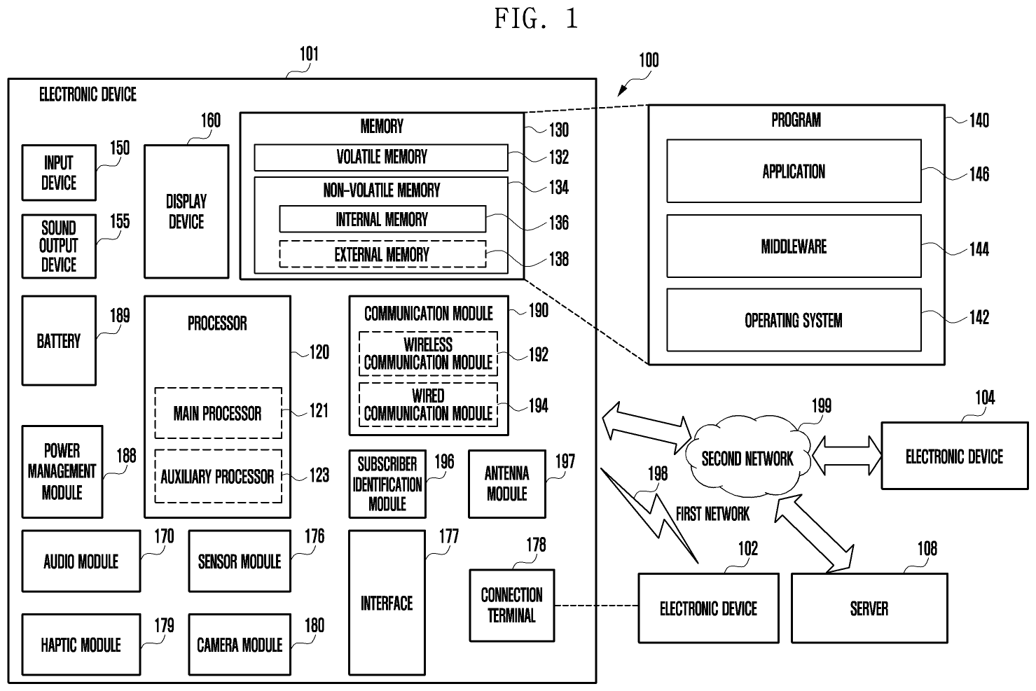

FIG. 1 illustrates an electronic device 101 in a network environment 100 according to an embodiment.

Referring to FIG. 1, the electronic device 101 in the network environment 100 may communicate with an electronic device 102 via a first network 198 (e.g., a short-range wireless communication network), with an electronic device 104 or a server 108 via a second network 199 (e.g., a long-range wireless communication network), or with the electronic device 104 via the server 108, and may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) card 196, and an antenna module 197. At least one the display device 160 or the camera module 180) of the components may be omitted from the electronic device 101, or one or more other components may be added in the electronic device 101. Some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. The processor 120 may load a command or data received from another component (e.g., the sensor module 176 or the communication module 190) in the volatile memory 132, process the command or the data stored in the volatile memory 132, and store resulting data in non-volatile memory 134. The processor 120 may include a main processor 121 a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). The auxiliary processor 123 (e.g., an ISP or a CP) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101 and may include software (e.g., the program 140) and input data or output data for a command related thereto. The memory 130 may include the volatile memory 132 or the non-volatile memory 134.

The program 140 may be stored in the memory 130 as software, and may include an operating system (OS) 142, middleware 144, or an application 146.

The input device 150 may receive a command or data to be used by another component (e.g., the processor 120) of the electronic device 101, from the outside (e.g., a user) of the electronic device 101, and may include a microphone, a mouse, a keyboard, or a digital pen (e.g., a stylus pen).

The sound output device 155 may output sound signals to the outside of the electronic device 101 and may include a speaker or a receiver. The speaker may be used for general purposes, such as playing multimedia or playing record, and the receiver may be used for incoming calls and may be implemented as separate from, or as part of the speaker.

The display device 160 may visually provide information to the outside (e.g., a user) of the electronic device 101 and may include a display, a hologram device, or a projector and control circuitry to control a corresponding one of the display, hologram device, and projector. The display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa, and may obtain the sound via the input device 150, or output the sound via the sound output device 155 or a headphone of an external electronic device (e.g., an electronic device 102) directly (e.g., over wires) or wirelessly coupled with the electronic device 101.

The sensor module 176 may detect an operational state (e.g., power or temperature) of the electronic device 101 or an environmental state a state of a user) external to the electronic device 101, and generate an electrical signal or data value corresponding to the detected state, and may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., over wires) or wirelessly, and may include a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102), and may include an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation, and may include a motor, a piezoelectric element, or an electric stimulator.

The camera module 180 may capture a still image or moving images and may include one or more lenses, image sensors, ISPs, or flashes.

The power management module 188 may manage power supplied to the electronic device 101, and may be implemented as at least part of a power management integrated circuit (PMIC).

The battery 189 may supply power to at least one component of the electronic device 101, and may include a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and supports a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., a LAN or a wide area network (WAN)). These various types of communication modules may be implemented as a single component (e.g., a single chip), or may be implemented as multi components (e.g., multi chips) separate from each other.

The wireless communication module 192 may identify and authenticate the electronic device 101 in a communication network, such as the first network 198 or the second network 199, using subscriber information (e.g., international mobile subscriber identity (IMSI)) stored in the SIM 196.

The antenna module 197 may transmit or receive a signal or power to or from the outside (e.g., the external electronic device) of the electronic device 101 and may include an antenna including a radiating element composed of a conductive material or a conductive pattern formed in or on a substrate (e.g., a printed circuit board (PCB)). The antenna module 197 may include a plurality of antennas. In such a case, at least one antenna appropriate for a communication scheme used in the communication network, such as the first network 198 or the second network 199, may be selected by the communication module 190 (e.g., the wireless communication module 192) from the plurality of antennas. The signal or the power may then be transmitted or received between the communication module 190 and the external electronic device via the selected at least one antenna. Another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the electronic devices 102 and 104 may be a device of a same type as, or a different type, from the electronic device 101.

All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related. to the request, and transfer an outcome of the performing to the electronic device 101. The electronic device 101 may provide the outcome, with or without further processing, as at least part of a reply to the request. To that end, a cloud, distributed, or client-server computing technology may be used, for example.

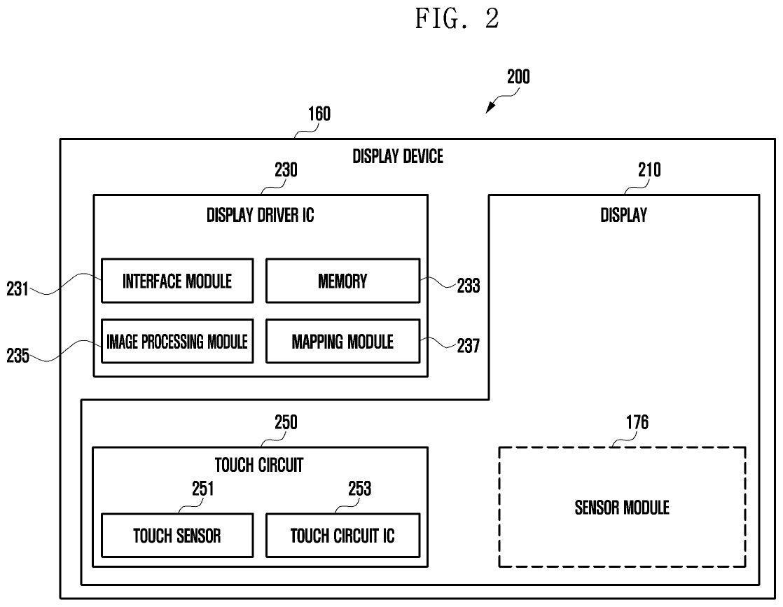

FIG. 2 is a block diagram 200 illustrating the display device 160 according to an embodiment.

Referring to FIG. 2, the display device 160 may include a display 210 and a display driver integrated circuit (DDI) 230 to control the display 210. The DDI 230 may include an interface module 231, memory 233 (e.g., buffer memory), an image processing module 235, or a mapping module 237.

The DDI 230 may receive image information that contains image data or an image control signal corresponding to a command to control the image data from another component of the electronic device 101 via the interface module 231. For example, according to an embodiment, the image information may be received from the processor 120 (e.g., the main processor 121 (e.g., an AP)) or the auxiliary processor 123 (e.g., a GPU) operated independently from the function of the main processor 121. The DDI 230 may communicate, for example, with touch circuitry 350 or the sensor module 176 via the interface module 23 1. The DDI 230 may also store at least part of the received image information in the memory 233, for example, on a frame by frame basis.

The image processing module 235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 210.

The mapping module 237 may generate a voltage value or a current value corresponding to the image data pre-processed or post-processed by the image processing module 235. According to an embodiment, the generating of the voltage value or current value may be performed, for example, based at least in part on one or more attributes of the pixels (e.g., an array, such as a red, green, blue (RGB) stripe or a pentile structure, of the pixels, or the size of each subpixel). At least some pixels of the display 210 may be driven, for example, based at least in part on the voltage value or the current value such that visual information (e.g., a text, an image, or an icon) corresponding to the image data may be displayed via the display 210.

According to an embodiment, the display device 160 may further include the touch circuitry 250. The touch circuitry 250 may include a touch sensor 251 and a touch sensor integrated circuit (IC) 253 to control the touch sensor 251. The touch sensor IC 253 may control the touch sensor 251 to sense a touch input or a hovering input with respect to a certain position on the display 210. To achieve this, for example, the touch sensor 251 may detect (e.g., measure) a change in a signal (e.g., a voltage, a quantity of light, a resistance, or a quantity of one or more electric charges) corresponding to the certain position on the display 210. The touch circuitry 250 may provide input information (e.g., a position, an area, a pressure, or a time) indicative of the touch input or the hovering input detected via the touch sensor 251 to the processor 120. According to an embodiment, at least part (e.g., the touch sensor IC 253) of the touch circuitry 250 may be formed as part of the display 210 or the DDI 230, or as part of another component (e.g., the auxiliary processor 123) disposed outside the display device 160.

According to an embodiment, the display device 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 210, the DDI 230, or the touch circuitry 250)) of the display device 160. For example, when the sensor module 176 embedded in the display device 160 includes a biometric sensor (e.g., a fingerprint sensor), the biometric sensor may obtain biometric information (e.g., a fingerprint image) corresponding to a touch input received via a portion of the display 210. As another example, when the sensor module 176 embedded in the display device 160 includes a pressure sensor, the pressure sensor may obtain pressure information corresponding to a touch input received via a partial or whole area of the display 210. According to an embodiment, the touch sensor 251 or the sensor module 176 may be disposed between pixels in a pixel layer of the display 210, or over or under the pixel layer.

The electronic device 101 according to embodiments may be one of various types of electronic devices, such as a portable communication device (e.g., a smartphone), a computer device, a portable multimedia device, a portable medical device, a camera, a wearable device, or a home appliance. However, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term. “operatively” or “communicatively”, as “coupled with,” “coupled to,” “connected with,” or “connected to” another element (e.g., a second element), it means that the element may be coupled with the other element directly (e.g., over wires), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

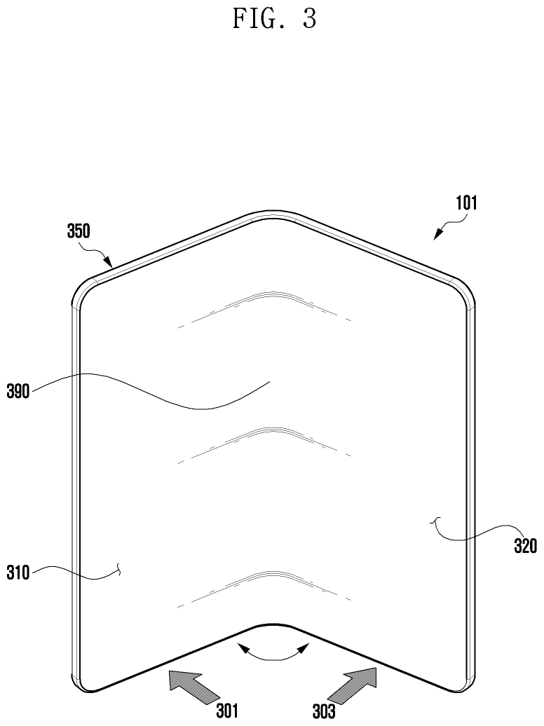

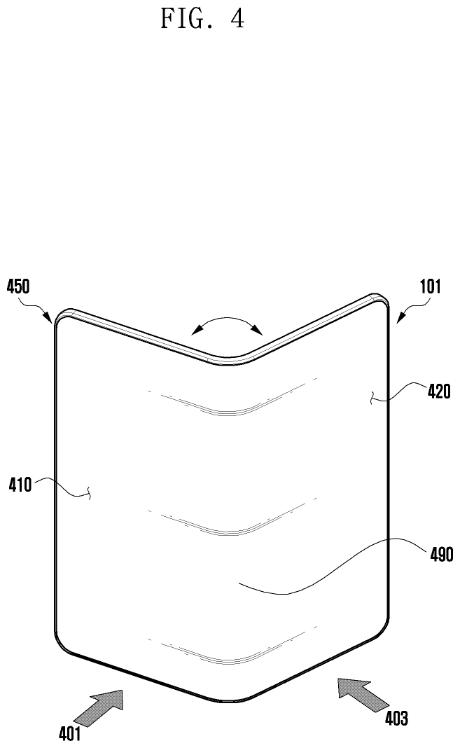

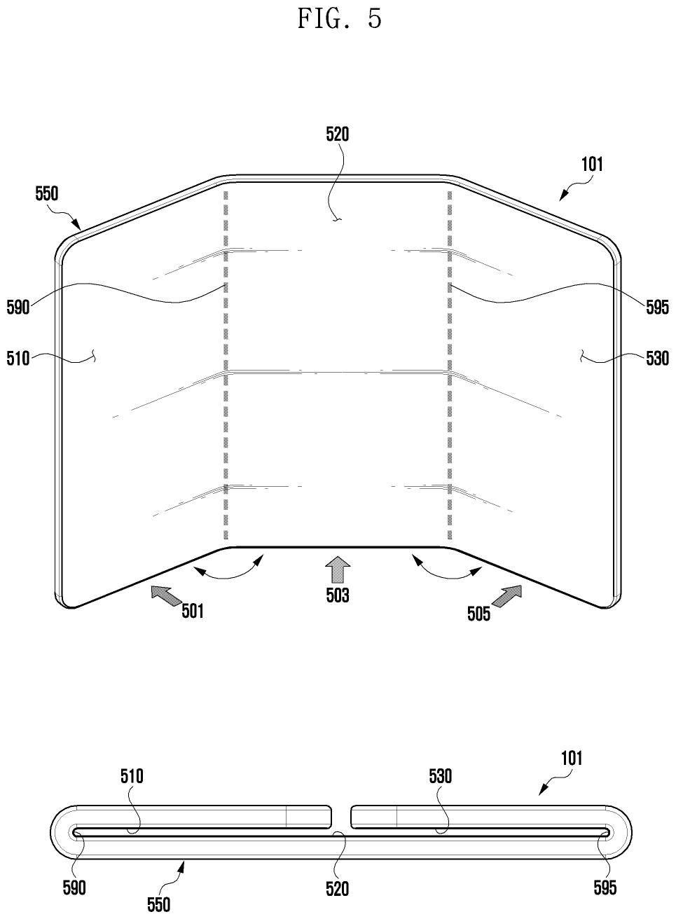

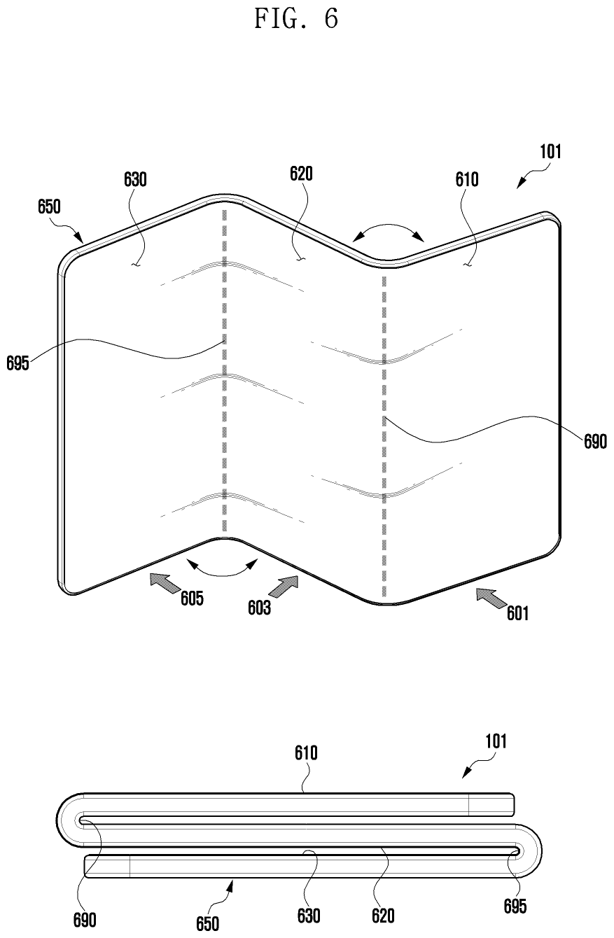

FIG. 3 illustrates an electronic device according to an embodiment, FIG. 4 illustrates an electronic device according to an embodiment, FIG. 5 illustrates an electronic device according to an embodiment, and FIG. 6 illustrates an electronic device according to an embodiment. More specifically, FIGS. 3, 4, 5, and 6 illustrate examples in which the shape of a foldable (or flexible) display is changed according to the type of the display. The display may be folded and unfolded in various ways according to the implemented shape of the electronic device 101.

Referring to FIGS. 3 and 4, the electronic devices 101 have one folding axis. In FIGS. 3 and 4, the electronic devices 101 include two display surfaces (e.g., a first display surface and a second display surface).

Referring to FIGS. 5 and 6, the electronic devices 101 have two folding axes. In FIGS. 5 and 6, the electronic device 101 includes three display surfaces (e.g., a first display surface, a second display surface, and a third display surface).

The number of folding axes in the electronic devices 101 is not limited to the examples illustrated in FIGS. 3-6.

The electronic device 101 may be a foldable device which can be folded and unfolded. The electronic device 101 may be equipped with a foldable (or flexible) device, and can be used in the folded state or the unfolded state. For example, when an in-folding-type electronic device 101 is folded (e.g., as illustrated in FIG. 3 or FIG. 5), the electronic device 101 may be in the state in which a first display surface (or a first region) and a second display surface (or a second region) of a display are at least partially in contact with each other so as to be closed about a folded point (e.g., a folding axis or a hinge axis). As another example, when an out-folding-type electronic device 101 is folded (e.g., as illustrated in FIG. 4), the electronic device 101 may be in the state in which a first portion and a second portion of a housing (or a cover) are at least partially in contact with each other so as to be closed about a folded point (e.g., a folding axis or a hinge axis). As another example, when an in/out-folding-type electronic device 101 is folded (e.g., as illustrated in FIG. 6), the electronic device 101 may be in a state in which a first portion and a second portion of a housing are at least partially in contact with each other so as to be closed about a first folded point (e.g., a first folding axis), and a first display surface (or a first region) and a second display surface (or a second region) of a display are at least partially in contact with each other so as to be closed about a second folded point (e.g., a second folding axis). As another example, when the electronic device 101 is unfolded (e.g., in the unfolded state), all display surfaces (or regions) of the display are provided as one surface (or the entire surface) so that the display can be used in a relatively large size. Each of FIG. 3, 4, 5, and 6 illustrate a state in which the electronic device 101 is unfolded at a predetermined angle.

The electronic device 101 illustrated in FIG. 3, 4, 5, or 6 may include a processor and one DDI operatively or electrically connected to the display. For example, the first display surface and the second display surface may be connected to one DDI. The disclosure, however, is not limited thereto, and the electronic device 101 may include a first DDI operatively or electrically connected to the first display surface and a second DDI operatively or electrically connected to the second display surface. The first display surface and the second display surface may be operatively or electrically connected to each other, and may be formed by one display (e.g., a foldable display or a flexible display).

In the electronic device 101, the display may be folded or unfolded in various ways (e.g., in-folding, out-folding, or in/out-folding) depending on the implemented form of the electronic device 101.

Referring to FIG. 3, the electronic device 101 includes a housing 350 that fixes the display including a first display surface 310 (or a first region) and a second display surface 320 (or a second region). The housing 350 may include a foldable structure (e.g., a hinge structure), and may be configured such that the first portion 301 and the second portion 303 are oriented in opposite directions in the folded state and are oriented in the same direction in the unfolded state.

The electronic device 101 includes a vertical folding axis 390 passing through the center of the electronic device 101 (e.g., the center of the display or the portion between the first display surface 310 and the second display surface 320). The electronic device 101 may be folded, unfolded, or bent about the folding axis 390. FIG. 3 illustrates the form in which the first display surface 310 and/or the second display surface 320 of the electronic device 101 are folded inwards such that the display is not exposed to the outside.

In the electronic device 101 illustrated in FIG. 3, when the electronic device 101 is fully folded (e.g., the folded state), any two portions included in the display (e.g., the first display surface 310 and the second display surface 320) in the electronic device 101 face each other such that the two portions are completely or substantially parallel to each other. For example, when the electronic device 101 is fully folded, the two portions of the electronic device 101 are not necessarily in contact with each other, but are disposed in close proximity. In the electronic device 101 illustrated in FIG. 3, when the electronic device 101 is fully unfolded (e.g., in the unfolded state), the first display surface 310 and the second display surface 320 of the electronic device 101 are exposed and may form a flat surface like a single display, and that the area of the display exposed to the outside is the largest or approaches the largest possible area.

Referring to FIG. 4, the electronic device 101 includes a housing 450 that fixes the display including a first display surface 410 (or a first region) and a second display surface 420 (or a second region). The housing 450 may include a foldable structure (e.g., a hinge structure), and may be configured such that a first portion 401 and a second portion 403 are oriented in opposite directions in the folded state and are oriented in the same direction in the unfolded state.

The electronic device 101 includes a vertical folding axis 490 passing through the center of the electronic device 101. The electronic device 101 may be folded, unfolded, or bent about the folding axis 490. FIG. 4 illustrates the form in which the first display surface 410 and the second display surface 420 of the electronic device 101 is folded outwards such that the display is exposed to the outside.

In the electronic device 101 illustrated in FIG. 4, when the electronic device 101 is fully folded, two portions (e.g., the housing) included in one surface (e.g., the rear surface) of the electronic device 101 on which the display is not implemented face each other such that the two portions are completely or substantially parallel to each other. For example, when the electronic device 101 is fully folded, the two portions included in the one surface of the electronic device 101 are not necessarily in contact with each other, but are disposed in close proximity. In the electronic device 101 illustrated in FIG. 4, when the electronic device 101 is fully unfolded, the first display surface 410 and the second display surface 420 of the display 210 of the electronic device 101 are exposed to the outside in the state of forming a flat surface like a single display, and that the area of the display exposed to the outside is the largest or approaches the largest possible area.

In FIGS. 3 and 4, the folding axes 390 are 490 is illustrated at the centers of the electronic devices 101, but are not limited thereto. For example, the folding axis 390 or 490 may be present at an arbitrary position in the electronic device 101. For example, the electronic device 101 may be asymmetrically folded or bent with respect to the folding axis 390 or 490, and in the state in which the electronic device 101 is folded, the facing sizes of two display surfaces (or two regions) divided by the folding axis 390 or 490 (or the sizes of respective display surfaces divided after being folded) may be different from each other. In addition, depending on the degree of folding of the electronic device 101, the electronic device 101 may take the fully folded form, or may take an intermediate form between the fully folded form and the fully unfolded form.

The electronic device 101 may detect the folded state or the degree of folding of the electronic device 101. The electronic device 101 may detect the folded state or the degree of folding, and may activate or deactivate a portion of the display surface (or a partial region) of the display adopted in the electronic device 101. In FIG. 3, when the electronic device 101 detects the folded state of the electronic device 101, all of the display surfaces (i.e., the first display surface 310 and the second display surface 320) may be deactivated. In FIG. 4, when the electronic device 101 detects the folded state thereof, the electronic device 101 may determine which of the first display surface 410 or the second display surface 420 is being used, and, based on the result of the determination, may activate the surface that is being used in the display and may deactivate the other surface that is not being used in the display.

Referring to FIG. 5, the electronic device 101 includes a housing 550 that fixes the display including a first display surface 510 (or a first region), a second display surface 520 (or a second region), and a third display surface 530 (or a third region). The housing 550 may include a foldable structure (e.g., a hinge structure), and may be configured such that in the folded state, the first portion 501 and the third portion 505 are oriented in a direction opposite a direction in which the second portion 503 is oriented and the first portion 501 and the third portion 503 are oriented in the same direction, and in the unfolded state, the first portion 501, the second portion 503, and the third portion 503 are oriented in the same direction.

In FIG. 5, the electronic device 101 includes two folding axes 590 and 595. The two folding axes 590 and 595 may be adopted in a vertical direction so as to divide the electronic device 101 into three equal portions. The electronic device 101 may be folded, unfolded, or bent about the folding axes 595 and 595. For example, FIG. 5 illustrates an electronic device 101 of a G-fold type, in which the electronic device 101 viewed from the front side in the unfolded state and the electronic device 101 viewed from the rear side in the folded state are illustrated in the drawing.

The electronic device 101 illustrated in FIG. 5 may have different folding or bending directions with respect to the folding axes 590 and 595. However, this is an example, and the electronic device 101 may be folded or bent in the same direction about each of the folding axes 590 and 595. The electronic device 101 may be folded such that the first display surface 510 and the second display surface 520 of the display face each other and such that the second display surface 520 and the third display surface 530 face each other. Various embodiments are not limited thereto.

When the electronic device 101 illustrated in FIG. 5 is folded in an out-folding type, the electronic device 101 may be folded such that the first display surface 510, the second display surface 520, and the third display surface 520 are exposed to the outside, the rear surface of the first display surface 510 and the rear surface of the second display surface 520 face each other, and the rear surface of the second display surface 520 and the rear surface of the third display surface 530 face each other.

Depending on the positions at which the two folding axes 590 and 595 are adopted on the electronic device 101, the electronic device 101 may be asymmetrically folded or bent with respect to each of the folding axes 590 and 595. Even when the electronic device 101 is fully folded with respect to the folding axes 590 and 595, respective display surfaces (or respective regions) of the electronic device 101, which are divided by the folding axes 590 and 595, may not fully overlap each other. Even when the electronic device 101 as illustrated in FIG. 5 includes the folding axes 590 and 595, the display may be adopted on the front surface and/or the rear surface of the electronic device 101. The display used in the electronic device 101 may be activated or deactivated in a similar manner to that described above with reference to FIGS. 3 and 4.

Referring to FIG. 6, the electronic device 101 includes a housing 650 that fixes the display 210 including a first display surface 610 (or a first region), a second display surface 620 (or a second region), and a third display surface 630 (or a third region). The housing 650 may include a foldable structure (e.g., a hinge structure), and may be configured such that, in the folded state, the first portion 601 and the third portion 605 are oriented in a direction opposite the direction in which the second portion 603 is oriented and the first portion 601 and the third portion 603 are oriented in the same direction, and in the unfolded state, the first portion 601, the second portion 603, and the third portion 605 are all oriented in the same direction.

In FIG. 6, the electronic device 101 includes two folding axes 690 and 695. The two folding axes 690 and 695 may be adopted in a vertical direction so as to divide the electronic device 101 into three equal portions. The electronic device 101 may be folded, unfolded, or bent about the folding axes 690 and 695. For example, FIG. 6 illustrates an electronic device 101 of an S-fold type, in which the electronic device 101 viewed from the front side in the unfolded state and the electronic device 101 viewed from the rear side in the folded state are illustrated in the drawing.

The electronic device 101 illustrated in FIG. 6 may have different folding or bending directions with respect to the folding axes 690 and 695. For example, the electronic device 101 may be folded or bent in the same direction about each of the folding axes 690 and 695. The electronic device 101 may be folded such that the first display surface 610 of the display is exposed to the outside, the rear surface of the first display surface 610 and the rear surface of the second display surface 620 face each other, and the second display surface 620 and the third display surface 630 of the display face each other.

Depending on the positions at which the two folding axes 690 and 695 are adopted on the electronic device 101, the electronic device 101 may be asymmetrically folded or bent with respect to each of the folding axes 690 and 695. Even when the electronic device 101 is fully folded with respect to the folding axes 690 and 695, respective display surfaces (or respective regions) of the electronic device 101, which are divided by the folding axes 690 and 695 may not fully overlap each other. Even when the electronic device 101 in FIG. 6 includes the folding axes 690 and 695, the display may be adopted on the front surface and/or the rear surface of the electronic device 101. The display used in the electronic device 101 may be activated or deactivated in a manner similar to that described above with reference to FIGS. 3 and 4.

The electronic device 101 may detect a shape change (e.g., folding or unfolding) of the display based on various methods.

The electronic device 101 may include a state detection sensor based on at least one sensor. The state detection sensor may include at least one of a proximity sensor, an illuminance sensor, a magnetic sensor, a hall sensor, a gesture sensor, a bending sensor, an infrared sensor, a touch sensor, a pressure sensor, or an infrared camera. The state detection sensor may be located on any one portion of the electronic device 101 (e.g., a folding axis, a housing end, the lower end of the display (e.g., under the panel or on the bezel of the display)) so as to measure the unfolding or folding) angle of the electronic device 101. The unfolding angle may mean the angle between two display surfaces divided by each folding axis of the electronic device 101. The electronic device 101 may determine whether the electronic device 101 is fully folded, fully unfolded, or unfolded (or folded) by a predetermined angle based on the unfolding angle measured by the state detection sensor. For example, when the unfolding angle measured by the state detection sensor is about 180 degrees or an angle close thereto, the electronic device 101 may determine that the display thereof is fully unfolded (e.g., in the unfolded state). For example, when the unfolding angle measured by the state detection sensor is about 0 degrees or an angle close thereto, the electronic device 101 may determine that the display thereof is fully folded (e.g., in the folded state). When the measured unfolding angle is within a predetermined angular range based on data acquired from at least one sensor of the state detection sensor, the electronic device 101 may determine that the display thereof is folded, bent, or unfolded by a predetermined degree.

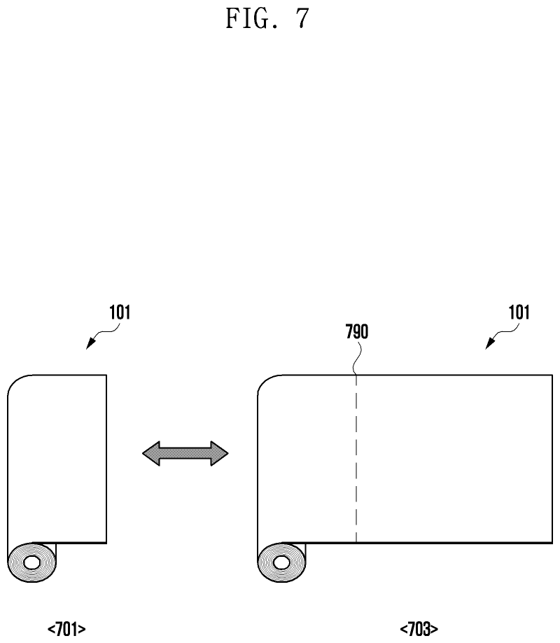

FIG. 7 illustrates an electronic device according to an embodiment. Specifically, FIG. 7 illustrates a rollable device including a roll-up-type (or rollable) display.

Referring to FIG. 7, when the electronic device 101 is implemented in the form of a rollable device, depending on the degree to which the user unrolls the electronic device 101 rolled in a cylindrical shape, the display of the electronic device 101 may be exposed to the outside in a relatively narrow area, as in Example <701>, or may be exposed to the outside in a relatively wide area, as in Example <703>. For example, when the display is exposed to the outside in a relatively narrow area, as in Example <701>(e.g., when the display is unrolled in a first set range), the electronic device 101 may be used in a first type (e.g., in a rolled state or in a bar type). As another example, when the display is exposed to the outside in a relatively wide area, as in Example <703> when the display is unrolled in a second set range), the electronic device 101 may be used in a second type (e.g., in an unrolled state or in a tablet type or expanded-display type).

The electronic device 101 may acquire information related to the size of the region of the display exposed to the outside based on the degree of unrolling curvature of the display 210 (e.g., the radius of curvature). For example, the electronic device 101 may measure the unrolling curvature of the display (or the electronic device 101) using the state detection sensor. In the electronic device 101, a threshold curvature may be predetermined in order to measure the degree of unrolling curvature. Accordingly, the electronic device 101 may acquire information on the size of the region of the display unrolled with a curvature greater than the threshold curvature. Based on the acquired information on the size, the electronic device 101 may determine whether the electronic device 101 is used in the first form (e.g., in the rolled state), as in Example <701>, or in the second form (e.g., in the unrolled state), as in Example <703>.

The electronic device 101 may have a virtual threshold line 790 provided on the display in order to acquire information on the size of the region of the display exposed to the outside in the electronic device 101. For example, the electronic device 101 may acquire information on a difference in curvature between two adjacent portions located in opposite directions with respect to the threshold line 790 on the display using the state detection sensor. When the difference in curvature is greater than a predetermined value, the electronic device 101 may determine that the display is exposed to the outside by an area exceeding the threshold line 790. Based on the acquired information on the size, the electronic device 101 may determine whether the electronic device 101 is used in the first form (e.g., in the rolled state) as in Example <701> or in the second form (e.g., in the unrolled state) as in Example <703>.

As described above with reference to FIGS. 3 to 7, the electronic devices 101 may include a foldable, flexible, or rollable display, which can be folded, bent, rolled, unfolded, or unrolled. For example, the electronic devices 101 may be folded, bent, or unfolded with respect to one or more folding axes, as illustrated in FIGS. 3, 4, 5, and 6, or may be rolled in a cylindrical shape or unrolled therefrom, as illustrated in FIG. 7. The electronic devices 101 may have various shapes depending on whether the electronic devices 101 are folded, bent, rolled, unfolded, or unrolled, or the degree of being folded, bent, rolled, unfolded, or unrolled.

Although the embodiments above include a display that is foldable about a vertical axis by way of example, the embodiments are not limited thereto. The disclosure may he applied to a display that is foldable about a horizontal axis, and the electronic devices 101 may have displays having various shapes. Accordingly, an electronic device 101 may be folded or unfolded about one or more folding axes.

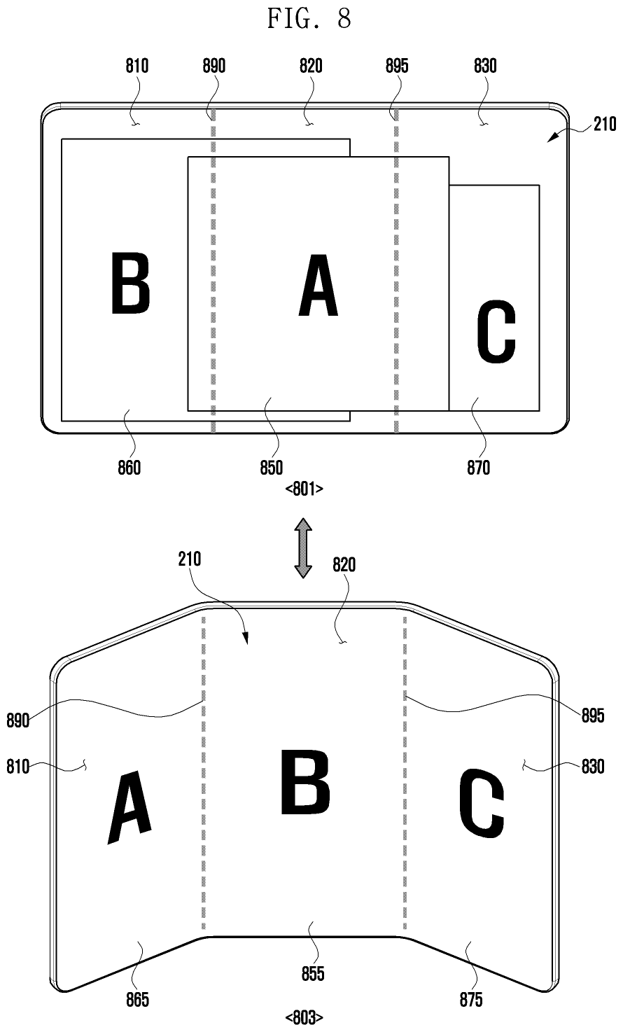

FIG. 8 illustrates an operation of a display based on a state of a display in an electronic device according to an embodiment. Specifically, FIG. 8 illustrates an example in which in an electronic device provides a UI according to a state change of the display.

Referring to FIG. 8, the electronic device includes two folding axes (or hinge axes). However, the embodiment is illustrative, and is not limited to two axes. Accordingly, the electronic device the display 210 of the electronic device is divided into multiple portions (e.g., three equal portions or four equal portions).

The electronic device includes two vertical folding axes 890 and 895 (or hinge axes) in the display 210. The electronic device may be folded (or bent) or unfolded about the folding axes 890 and 895. In FIG. 8, the display 210 includes two folding axes 890 and 895, with a first region 810 (or a first display surface), a second region 820 (or a second display surface), and a third region 830 (or a third display surface). The display 210 may be folded inwards such that the display 210 is not exposed to the outside of the electronic device (e,g., an in-fold type).

Although the screen of the display 210 in FIG. 8 is divided into three regions, such as the first region 810, the second region 820, and the third region 830, depending on the state of being folded about the two folding axes 890 and 895, the disclosure is not limited thereto, and the electronic device may take a form in which at least one of the first region 810, the second region 820, and the third region 830 of the display 210 is folded outwards so as to be exposed to the outside of the electronic device (e.g., an out-folding or in/out-folding type).

The electronic device may identify the folded state of the display 210 (e.g., the fully folded state), the unfolded state of the display 210 (e.g., the fully unfolded state), or a partially folded (or unfolded) state) (e.g., a degree of folding). The electronic device may identify the state of the display 210, and may activate or deactivate at least one region included in the display 210 (e.g., the first region 810, the second region 820, or the third region 830). When the electronic device identifies the folded state of the display 210, the display 210 may be deactivated.

In Example <801> of FIG. 8, three objects (e.g., a first object 850, a second object 860, and a third object 870) (e.g., UIs (or windows) of application execution screens) are displayed in the unfolded state. In the unfolded state, the electronic device may respectively display the first object 850 (e.g., the UI of application A execution screen), the second. object 860 (e.g., the UI of application B execution screen), and the third object 870 (e.g., the UI of application C execution screen) through arbitrary regions of the display 210. The first object 850 is displayed aver the first region 810, the second region 820, and the third region 830 of the display 210, in which the greatest portion thereof is included in the second region 820. The second object 860 is displayed over the first region 810 and the second region 820 of the display 210, and is at least partially covered by the first object 850 (or the state in which the first object 850 is overlaid or superimposed on the second object 860). For example, the second object 860 may be disposed in a lower layer than the layer for the first object 850. The third object 870 is displayed over the second region 820 and the third region 820 of the display 210 and is at least partially covered by the first object 850 (or the state in which the first object 850 is overlaid or superimposed on the third object 870). For example, the third object 870 may be disposed in a lower layer than the layer in which the first object 850 is disposed.

In Example <803> of FIG. 8, the electronic device is in a state in which the first portion including the first region 810 and the third portion including the third region 830 are folded at a predetermined angle between the folded state and the unfolded state of Example <801>. As illustrated in Example <803>, when the electronic device is folded within a designated range (or by a designated angle) from the unfolded state, the display 210 may be divided into at least two regions (e.g., screen division) based on folded target regions (or the number of target regions). When the portion of the first region 810 is folded by a predetermined angle about the first folding axis 890 or when the portion of the third region 830 is folded by a predetermined angle about the second folding axis 895, the display 210 may be divided into two regions (e.g., screen division). As another example, when the portion of the first region 810 is folded by a predetermined angle about the first folding axis 890 and when the portion of the third region 830 is folded by a predetermined angle about the second folding axis 895, the display 210 may be divided into three regions (e.g., screen division).

In Example <803>, the portion of the first region 810 and the portion of the third region 830 are folded by a predetermined angle about the first folding axis 890 and the second folding axis 895, respectively, so as to divide the display 210 into three regions 810, 820, and 830. For example, in Example <803>, the folded target regions include two regions, namely, the first region 810 and the third region 830.

When the electronic device is folded within a designated range (or by a designated angle) from the unfolded state, the electronic device may identify this operation as an operation event (or trigger) for screen division. In a specific state (e.g., the unfolded state), the electronic device identifies the corresponding state of the display 210 based on the operation event in which the state of the display 210 is changed, and may differently operate UIs related to respective objects 850, 860, and 870 provided on the display 210 based on the identified state of the display 210.

The electronic device may identify at least one target region and at least one object included in the target region based on the operation event. In Examples <801>and <803>, the electronic device may identify the first region 810 and the third region 830 as target regions, and may identify that the second object 860 is included in the first region 810 and the third object 870 is included in the third region 830.

The electronic device may divide the display into respective regions 810, 820, and 830 based on the folding axes 890 and 895, and may set the positions of the objects 850, 860, and 870 corresponding to the respective divided regions 810, 820, and 830. For example, the electronic device may set the first area 810, which is a first target region, as a region for the second object 860, may set the third region 830, which is a second target region, as a third object, and may set the second region 820, which is a main region (e.g., a remaining region other than the target regions or an unfolded region) as a region for the first object 850.

The electronic device may move the second object 860 to the first region 810 and may adjust the size of the second object 860 (e.g., the window size) through the first region 810 (e.g., the first display surface) so as to display the second object 860 as a full screen 865, may move the third object 870 to the third region 830 and may adjust the size of the third object 870 the window size) through the third region 830 (e.g., the third display surface) so as to display the third object 870 on the full screen 875, and may adjust the size of the first object 850 (e.g., the window size) through the second region 820 (or the second display surface) so as to display the first object 950 as a full screen 855. For example, based on a user's action of folding the display 210 by a predetermined angle (e.g., a physical gesture), the electronic device may move a corresponding object according to the folded region (or position), and may automatically adjust the window size of the object so as to display the object. Accordingly, it is possible to freely adjust a software window size of using a physical characteristic of the display 210 (e.g., the foldable or flexible characteristic), and it is also possible to provide the effect of using a multi-display through multiple division of the screen of the display 210 based on the physical gesture of the user (e.g., an action of folding the display 210 by a predetermined angle).

When moving an object and/or adjusting the window size corresponding to the object, the electronic device may provide a designated guide (e.g., a screen division guide), and based on a user interaction (or user input) for the guide (e.g., an action of additionally folding by a predetermined angle, designated touch input, or object selection input), the electronic device may rearrange the position and/or size corresponding to each object (a user interaction of the object) so as to display respective objects as illustrated in Example <803>.

Although FIG. 8 illustrates that when the display 210 is folded by a designated angle from the unfolded state, the objects 850, 860, and 870 are respectively provided as full screens 855, 864, and 875 of the regions 810, 820, and 830, as in Example <803>, the disclosure is not limited thereto. For example, the electronic device may operate a target region and a main region differently on the electronic device based on set information related to display operation. When the object in the target region is moved, the size of the object may be adjusted so as to provide the object as a full screen, the object in the main region may be provided in its original state without adjusting the size, and the object may be moved into the main region when necessary. As another example, the objects in the target region and the main region may be provided based on the original sizes thereof without adjusting the sizes.

The electronic device may be changed from the state (e.g., the state of being folded by a predetermined angle) as in Example <803> to the unfolded state as in Example <801>. The electronic device may provide the positions, sizes, and/or overlapping states corresponding to respective objects 850, 860, and 870 in the previous state based on the unfolded target regions (e.g., the first region 810 and/or the third area 830). The electronic device may provide UIs of the respective objects 850, 860, and 870 in the state before being folded based at least on state information (e.g., position information, size information, and/or priority information) of the respective objects 850, 860, and 870.

In the state in which the display 210 is folded within a designated range (or by a designated angle), the electronic device may restore the UIs related to the respective objects 860, 860, and 870 provided to the display 210 to the previous state (or the original state) and may provide the restored UIs based on an operation event in which the state of the display 210 is changed (e.g., unfolded). Based on the state information corresponding to the respective objects 850, 860, and 870, the electronic device may identify the restored positions, the restored sizes, and/or the overlapping state (or the displayed order) of the respective objects 850, 860, and 870.

As illustrated in Example <801>, based on position information, the electronic device may display the first object 850 over the first region 810, the second region 820, and the third region 830 of the display 210, may display the second object 860 over the first region 810 and the second region 820 of the display 210, and may display the third object 870 over the second area 820 and the third area 830 of the display 210. When providing each of the object 850, 860, and 870 to a corresponding region, the electronic device may restore the sizes of the respective objects 850, 860, and 870 (e.g., window sizes) to the previous sizes (e.g., based on a pop-up window) and display the restored objects 850, 860, and 870 based on size information. Based on priority information (e.g., e.g., the overlapping state), the electronic device may provide the state in which the second object 860 and the third object 870 are at least partially covered by the first object 850 (or the state in which the first object 850 is overlaid on the second object 860 and/or the third object 870).

Based on a user's action (e.g., a physical gesture) of unfolding the display 210, the electronic device may move the respective objects 850, 860, and 870, may automatically adjust the window sizes of the respective objects 850, 860, and 870, and may provide the adjusted windows according to the priorities thereof. Accordingly, it is possible to freely adjust a software window size using a physical characteristic of the display 210 (e.g., the foldable or flexible characteristic), and, based on the user's physical gesture (e.g., an action of unfolding the display 210), it is also possible to use a single screen (or a full screen) in which the respective regions 810, 820, and 830 of the display 210 are connected to each other.

According to an embodiment, an electronic device may include a display, a processor operatively connected to the display, and memory operatively connected to the processor. The memory is configured to store instructions that cause, when executed, the processor to: display one or more objects through the display; detect an operation event in which the display is switched from a first state to a second state; monitor a state change of the display based on the operation event; detect a state in which the display is folded to a designated angle; divide the display into a first display surface and a second display surface based on the state of being folded to the designated angle; and rearrange and display the one or more objects based on at least the first display surface or the second display surface,

The first display surface may include a display surface, which is folded about a folding axis in the display, and the second display surface may include a fixed display surface, which is not folded in the display.

The instructions may cause the processor to display a target object of at least one of the displayed objects on the first display surface of the display based on the state of being folded to the designated angle; and display a remaining object other than the target object on the second display surface of the display.

The instructions may cause the processor to determine, when a plurality of target objects related to the first display surface are present, priorities of the plurality of target objects; and determine an object to be displayed on the first display surface based on the priorities.

The instructions may cause the processor to identify a target object to be included in the first display surface; and store state information related to restoration of the identified target object.

The instructions may cause the processor to restore the target object to an original state based on at least the first display surface and/or the second display surface based on the state information, and provide the restored target object when the display is switched to an unfolded state.

The instructions may cause the processor to detect a trigger related to screen division at a first designated angle, and conduct an action for the trigger related to the screen division based on a designated trigger.

The instructions may cause the processor to provide a guide related to the screen division at the first designated angle, and execute the screen division based on the designated trigger in the state in which the guide is displayed.

The designated trigger may include at least one of a second designated angle, different from the first designated angle, for executing the screen division or a designated user interaction.

The instructions may cause the processor to identify the designated user interaction at the designated angle; and execute the screen division based on the identification of the user interaction.

According to an embodiment, an electronic device may also include a foldable display, a processor operatively connected to the foldable display, and memory operatively connected to the processor. The memory may be configured to store instructions that cause, when executed, the processor to detect an operation event in which the state of the foldable display is changed; monitor a state change of the foldable display based on the operation event; display at least one object included in a target region for a first state in a range greater than or equal to a designated range, and rearrange and display a remaining object in a main region when there is a first state change; and restore at least one object including an object included in a target region for a second state based on state information, and rearrange and display the at least one object through the target region and the main region when there is a second state change.

According to an embodiment, operations performed by an electronic device, as described below, may be executed by at least one processor of the electronic device (The operations performed by the electronic device may be executed by instructions that are stored in a memory and that cause, when executed, the processor to operate.

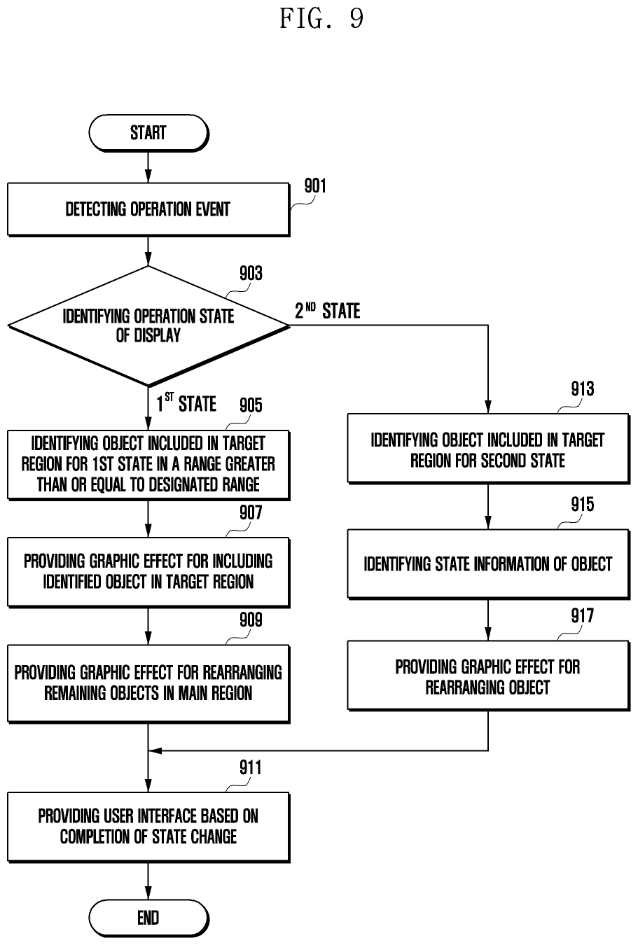

FIG. 9 is a flowchart illustrating a method of operating a display in an electronic device according to an embodiment.

Referring to FIG. 9, in step 901, the electronic device 101 detects an operation event (or trigger). For example, a processor of the electronic device may detect an operation event in which the state of the display is changed using at least one sensor. The states of the display may include a first state in which the display is changed from the unfolded state to a folded state by a designated angle, or a second state in which the display is changed from a folded state to an unfolded state.

In step 903, the electronic device identifies the operation state of the display, i.e., the first state or the second state. For example, when the operation event in which the state of the display is changed is detected, the electronic device may determine whether the state of the display is the first state or the second state. The processor may acquire data (e.g., sensor data) associated with the state change of the display from at least one sensor, and may identify the state of the display based on the acquired data. The at least one sensor may include a sensor (e.g., a smart hall sensor) that determines the state (e.g., the folded state or the unfolded state) of the electronic device (or the display of the electronic device), and/or a sensor (e.g., an acceleration sensor or a gyro sensor) that determines the rotation and orientation of the electronic device. That at least one sensor may include a touch sensor and/or a pressure sensor.

Based on a determination of the first state in step 903, in step 905, the electronic device identifies an object included in a target region according to the first state (e.g., a folded region (or a display surface) among the regions of the display or a region folded about the folding axis (or the hinge)) in a range greater than or equal to a designated range. The processor may identify at least one object included in a range greater than or equal to the designated range among the one or more objects included in the target region while maintaining the state of the main region (e.g., a fixed region (or a display surface), which is not folded, among the regions of the display). For example, the target region may be the first region 810 and/or the third region 830, which is folded by a predetermined angle by the user in the display, as illustrated in FIG. 8, and the main region may be the second region 820, which is maintained without being folded in the display as illustrated in FIG. 8.

In performing step 905, the processor may execute an operation of identifying an area folded in a designated range and identifying the region folded in the designated range as a target region (or a target display surface); an operation of identifying an object (e.g., a candidate object) including at least one partial region included in the target region; an operation of identifying state information (e.g., restoration positions, restoration sizes, and/or a display (or arrangement) order (or a priority)) related to (or corresponding to) objects in the target region and the main region; an operation of storing the identified state information in a memory; an operation of identifying an object included in the target region in a range greater than or equal to the designated range among the objects including at least one partial region; and/or an operation of identifying an operation time associated with folding. The operation time associated with folding may be identified based on the folding angle of the display.

While the electronic device 101 is changed from a fully unfolded state to a folded state, the processor may acquire data associated with the angle between the first region of the first portion of the housing and the second region of the second portion of the housing using at least one sensor. The processor may compare the acquired data and preset first reference data for identifying a first operation time at which the second state is changed to the first state, and when the acquired data corresponds to the first reference data, the processor 120 may determine that it is time to execute screen division of the display. The first reference data may be about 5 degrees, or may include an angle close thereto, but is not limited thereto. For example, the first reference data may include a predetermined angle between about 180 degrees, at which the display is fully unfolded, and about 0 degrees, at which the display is fully folded (e.g., about 10 degrees, about 15 degrees, or about 20 degrees).

In step 907, the electronic device provides a graphic effect of including (e.g., moving and/or size-adjusting) the identified object in the target region based on the detection of the first state change of the display. For example, the processor of the electronic device may provide a graphic effect of moving the identified object to the target region and displaying the object as a full screen within the target region by adjusting the size of the object (or the window size) according to a setting.

In step 909, the electronic device provides a graphic effect of rearranging and displaying a remaining object in the main region based on the detection of the first state change of the display. The processor may provide a graphic effect of moving the object of the main region into the main region according to a first setting (e.g., moving the object located over the target region into the main region) and adjusting the size (e.g., resizing) of the object (or the window size) so that the object is displayed within the main region. The processor may provide a graphic effect of displaying the object as a full screen within the main region by adjusting the size of the object (or the window size) in the main region according to a second setting.

Steps 907 and 909 are not limited to the order illustrated in FIG. 9, and may be performed sequentially, in parallel (or almost simultaneously), or in the reverse order.

In step 911, the electronic device provides a UI based on completion of the state change, e.g., as illustrated in Example <803> in FIG. 8.

The processor of the electronic device may provide a first UI of a first object as a full screen based on the target region folded by a predetermined angle, and may provide a second UI of a second object as a full screen based on the main region. The processor may provide objects in the target region and the main region in different ways depending on the operating method of the display set in the electronic device. For example, based on a first designated method, the processor may provide objects corresponding to the target region and the main region as a full screen based on a second designated method, the processor may provide the object in the target region as a full screen and may provide the object in the main region in the state in which the existing form (e.g., based on a pop-up window) is maintained, or, based on a third designated method, the processor may provide the object in the target region in the state in which the existing form (e.g., based on a pop-up window) is maintained, and may provide the object of the main region as a full screen.

However, based on the determination of the second state in step 903, in step 913, the electronic device identifies an object included in the target region according to the second state (e.g., an unfolded region among the regions of the display. For example, the processor may identify at least one object included in the target region while maintaining the state of the main region (e.g., a fixed region, which is not folded, among the regions of the display). The target region may be the first region 810 and/or the third region 830, which is unfolded by the user in the display, as illustrated in FIG. 8, and the main region may be the second region 820, which is maintained without being folded in the display, as illustrated in FIG. 8.

In step 913, the processor may perform an operation of identifying an unfolded region and identifying the unfolded region as a target region (or a target display surface), an operation of identifying at least one object included in the target region, and/or an operation of identifying an operation time associated with unfolding. The operation time associated with folding may be identified based on the unfolding angle of the display.

While the electronic device is changed from a folded state to an unfolded state, the processor may acquire data associated with the angle between the first region of the first portion of the housing and the second region of the second portion of the housing using at least one sensor. The processor may compare the acquired data and preset second reference data (e.g., reference data for identifying a second operation time, at which the first state is changed to the second state), and when the acquired data corresponds to the second reference data, the processor may determine that it is time to execute screen integration (e.g., to cancel screen division) of the display. The second reference data may be about 175 degrees, or may include an angle close thereto, but is not limited thereto. For example, the second reference data may include a predetermined angle between about 0 degrees, at which the display is fully folded, and about 180 degrees, at which the display is fully unfolded about 170 degrees, about 165 degrees, or about 160 degrees).

In step 915, the electronic device identifies state information associated with restoration of an object to a previous state. For example, the processor may identify state information (e.g., restoration positions, restoration sizes, and/or a display order (or a priority)) associated with (or corresponding to) the objects in the target region and the main region. The state information for restoration to the previous state may be information that is identified when the display changes to the first state and is stored in a memory.

In step 917, the processor provides a graphic effect of rearranging objects. For example, based on state information corresponding to the object, the processor may identify the restoration position, restoration size, and/or overlapping state (or display order) of each object based on position information, the processor may move the position of at least one object based on size information, the processor may restore the size of the at least one object (e.g., the window size) to the previous size (e.g., based on a pop-up window), and, based on priority information (e.g., overlapping state), the processor may provide a graphic effect of overlapping objects.

The processor may provide each UI corresponding to each object in the previous state based on the unfolded target region and the main region. The processor may provide a UI of each object in the state before folding (e.g., based on the full window and/or based on a pop-up window) based on the restoration position of each object.

When providing the UI of each object, the processor may identify the order of an object to be displayed based on the priority of each object. Based on the identified priority of each object, the processor may set the UI of the object having the highest priority as the highest level, and may provide UIs of other objects in the sequentially overlapping state.

The processor may provide a first object, which has been displayed at the highest level in the target region, and a second object, which has been displayed at the highest level in the main region, but when the UI of the first object and the UI of the second object overlap each other, the processor may assign a weight to the second object of the main region and may provide the UI of the second object such that the U1 of the second object overlaps the UI of the second object at a higher level than the UI of the first object. Additionally, objects other than the first object and the second object may be sequentially disposed on layers under the UI of the first object and/or the UI of the second object according to the positions and/or priorities thereof.

In step 911, the electronic device provides a UI based on completion of the state change, e.g., as illustrated in Example <801> of FIG. 8.

The processor may restore the UI of each object to the state before folding and provide the same through a full screen in which the target region and the main region are connected as a single screen.

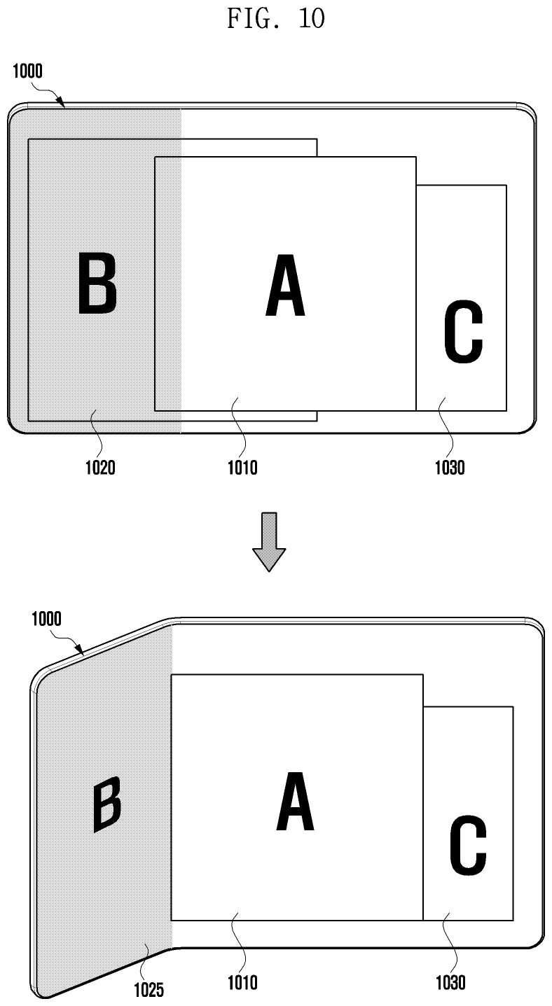

FIG. 10 illustrates a display in an electronic device according to an embodiment. More specifically, FIG. 10 illustrates an example in which, in an operation of folding at least one region (or a display surface) in the state in which the display is unfolded, a UI may be provided based on the priority of an object included in the folded region (e.g., the target region).

Referring to FIG. 10, multiple objects 1010 and 1020 or portions thereof are included in the target region 1000, and the object 1020 having the greatest area included in the target region 1000 has the highest priority.

For example, in FIG. 10, the first object 1010 and the second object 1020 are at least partially included in the target region 1000 and the second object 1020 has a greater area thereof included in the target region 1000 than the first object 1010. The electronic device may assign the highest priority to the second object 1020, among the first object 1010 and the second object 1020 included in the target region 1000, and may provide the second object 1020 as a full screen 1025 through the target region 1000.

The electronic device may identify an object included in the target region 1000 in a region greater than or equal to a designated range as a target object to be included in the target region 1000, and in FIG. 10, the first object 1010 may not be included in the target object. With respect to the first object 1010 and the third object 1030, the electronic device may maintain the state of being displayed through the main region, or may provide the first object 1010, which has a portion included in the target region 1000, in the state of being moved into the main region. The electronic device may provide the object having the highest priority (e.g., the first object 1010) as a full screen according to the priorities of the first object 1010 and the third object 1030 in the main region.

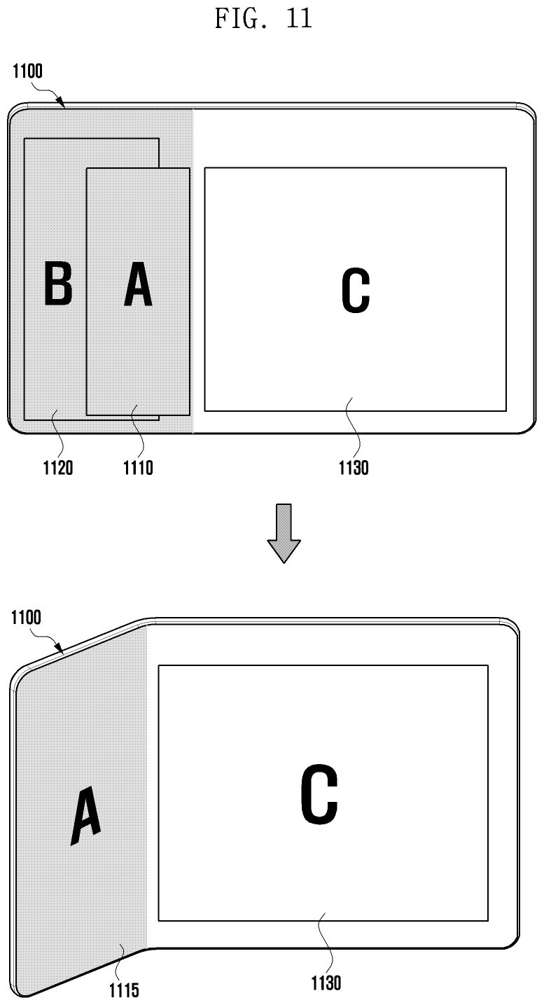

FIG. 11 illustrates an operation of a display in an electronic device according to an embodiment. More specifically, FIG. 11 illustrates an operation in which at least one region (or display surface) is folded in the state in which the electronic device is unfolded, and a UI may be provided based on the priority of an object included in the folded region (e.g., the target region).

Referring to FIG. 11, when all of multiple objects 1110 and 1120 are included in the target region 1100 (e.g when multiple objects 1110 and 1120 overlap each other in the target region 1100), the object 1110 located at the highest level in the target region 1100 has the highest priority.

For example, all portions of the first object 1110 and the second object 1120 may be included in the target region 1100. When all portions of the first object 1110 and the second object 1120 are included in the target region 1100 and have the same priority, the electronic device may assign the highest priority to the first object 1110, provided at the highest level among the first object 1110 and the second object 1120, which overlap each other in the target region 1100, and may provide the first object 1110 as a full screen 1115 through the target region 1100.

The electronic device may identify an object included in the target region 1100 in a range greater than or equal to a designated range as a target object to be included in the target region 1100, and in FIG. 11, both the first object 1110 and the second object 1120 may be included in a target object. Because the electronic device provides the first object 1110 as a full screen 11115 through the target region 1100, the second object 1120 included in the target region 1100 may not be displayed, but may be covered by the first object 1110. The electronic device may maintain the state in which the third object 1130 is displayed through the main region. The electronic device may provide the third object 1130 of the main region as a full screen.

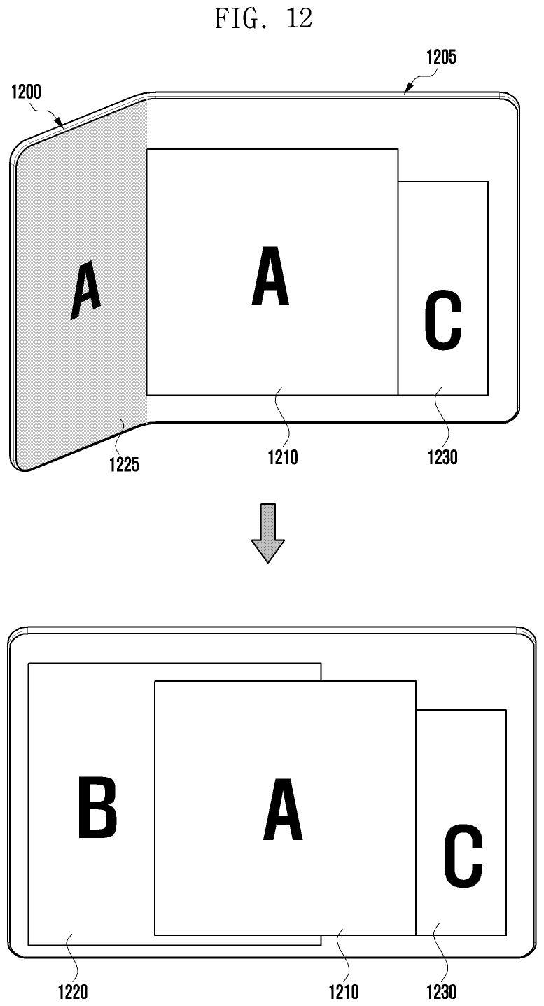

FIG. 12 illustrates an operation of a display in an electronic device according to an embodiment. More specifically, FIG. 12 illustrates an operation of changing at least one region to an unfolded state from the state in which the at least one region (or a display surface) of the display 210 has been folded in a designated range (e.g., the state in which screen division has been performed), an object included in the unfolded region (e.g., the target region) and an object included in a fixed region (e.g., the main region) are restored to the original state, and UIs for the objects are provided.

Referring to FIG. 12, at least one object 1220 is provided as a full screen 1225 in a target region 1200, and the at least one object 1220 of the target region 1200 is restored based on the original position, the size, and the priority thereof according to an operation of unfolding the display.

For example, FIG. 12 illustrates an example in which a second object 1220 is provided as a full screen 1225 in the target region 1200, a first object 1210 and a third object 1230 are provided in the main region 1205, and the first object 1210, the second object 1220, and the third object 1230 have higher priorities in that order. When there is no change in the state information (e.g., the positions, the sizes, and/or the priorities) of respective objects 1210, 1220, and 1230 during the switching from the folded state to the state unfolded in a designated range, the electronic device may restore respective objects 1210, 1220, and 1230 to the previous state so as to provide the restored objects 3210, 3220, and 3230.

The electronic device may identify the positions, the sizes, and/or the priorities of the second object 1220 of the target region 1200 and the first object 1210 and the third object 1230 of the main region 1205. Based on the positions, the sizes, and/or the priorities of respective objects 1210, 1220, and 1230, the electronic device may move the second object 1220 of the target region 1200 to the original position, and the electronic device may provide the first object 1210 at the highest level according to the priority thereof, and may sequentially arrange the second object 1220 and the third object 1230 under the first object 1210 according to the priorities thereof.

When there is a change in state information related to at least one of the objects 1210, 1220, and 1230 in the state of being folded within the specified range, the electronic device 101 may arrange the first object 1210, the second object 1220, and the third object 1230 and may provide the same based on the changed state information changed while being changed to the unfolded state. For example, when the folded state in the designated range is changed to the unfolded state in the state in which the user selects the third object 1230 of the main region 1205 and uses the third object 1230 at the highest level, the electronic device 101 may provide the third object 3230 at the highest level based on the changed priority thereof, and may sequentially arrange the first object 1210 and the second object 1220 under the third object 3230 according to the priorities thereof.

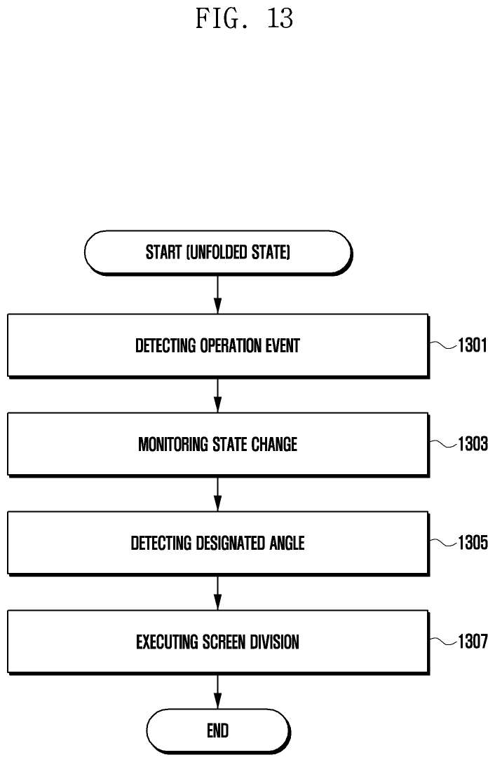

FIG. 13 is a flowchart illustrating a method of operating an electronic device according to an embodiment. More specifically, FIG. 13 illustrates an operation of executing screen division when the display of the electronic device is folded from the unfolded state (e.g., a screen division method according to setting of a first method). The setting of the first method may include setting to automatically execute screen division when switching from the unfolded state to a folded state of a designated angle. For example, the first method may the user automatically executing screen division based on a physical gesture of folding (or bending) a portion (e.g., a hinge portion) of the display by a predetermined angle.

Referring to FIG. 13, in step 1301, a processor of the electronic device detects an operation event (or trigger) in the unfolded state of the display. The processor may detect an operation event in which the state of the display is changed using at least one sensor.

In step 1303, the processor monitors a state change of the display. The processor may monitor the state change in which the display is folded (e.g., monitoring the change in a hinge angle) based on the operation event, and may monitor whether the state change corresponds to a designated angle for dividing the screen into a target region and a main region. The processor may acquire data (e.g., sensor data) associated with the state change of the display from at least one sensor, and may identify the state of the display based on the acquired data.

In step 1305, the processor detects the designated angle. While the display is changed from an unfolded state to a folded state, the processor may acquire data associated with the angle between the target region and the main region using at least one sensor. The processor may compare the acquired data and preset reference data (e.g., reference data for identifying a screen division execution time), and when the acquired data corresponds to the reference data, the processor may determine that it is time to execute screen division of the display. The reference data may be about M degrees, or may include an angle close thereto. The M degrees may include a predetermined angle designated (or set) by the user between 180 degrees, at which the display 210 is fully unfolded, and about 0 degrees, at which the display 210 is fully folded, such as about 10 degrees, about 15 degrees, or about 20 degrees,

In step 1307, the processor executes screen division. For example, the processor may execute screen division for dividing the display into a target region and a main region based on the designated angle, and may provide a corresponding object based on each region. When performing the screen division, the processor may provide a visual guide for screen division (or a screen division guide) at a designated angle.

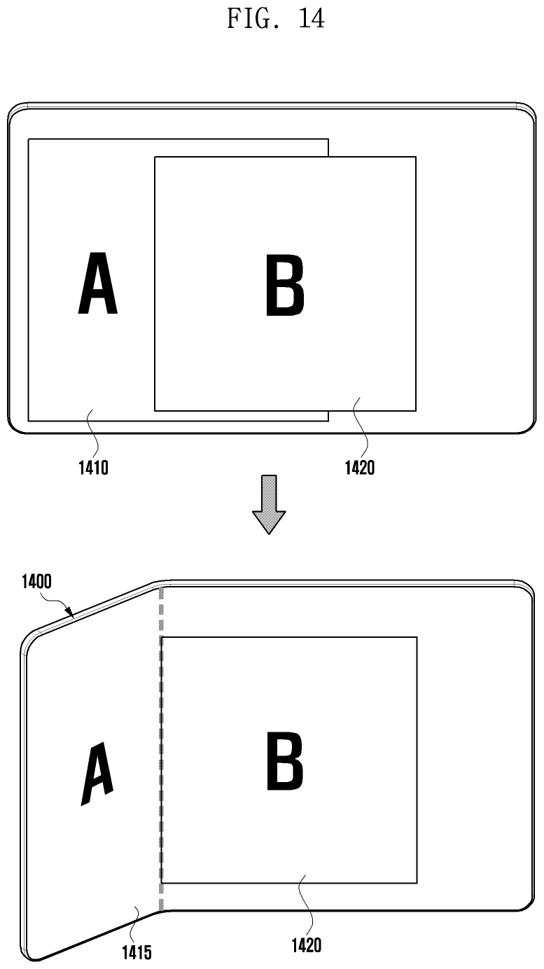

FIG. 14 illustrates executing screen division in an electronic device according to an embodiment. More specifically, FIG. 14 illustrates an example in which screen division is executed based on setting of the first method when at least one region (or display surface) of the display of the electronic device is folded from the unfolded state.

Referring to FIG. 14, a first object 1410 and a second object 1420 are provided through the display, and the first object 1410 may be a target object to be provided through a target region 1400. The electronic device may monitor an angle designated in an operation in which the target region 1400 is folded from the unfolded state of the display. Based on the time at which the target region 1400 is folded by a designated angle, the electronic device may provide the first object 1410 as a full screen 1415 through the target region 1400, and may provide the second object 1420 through the main region.

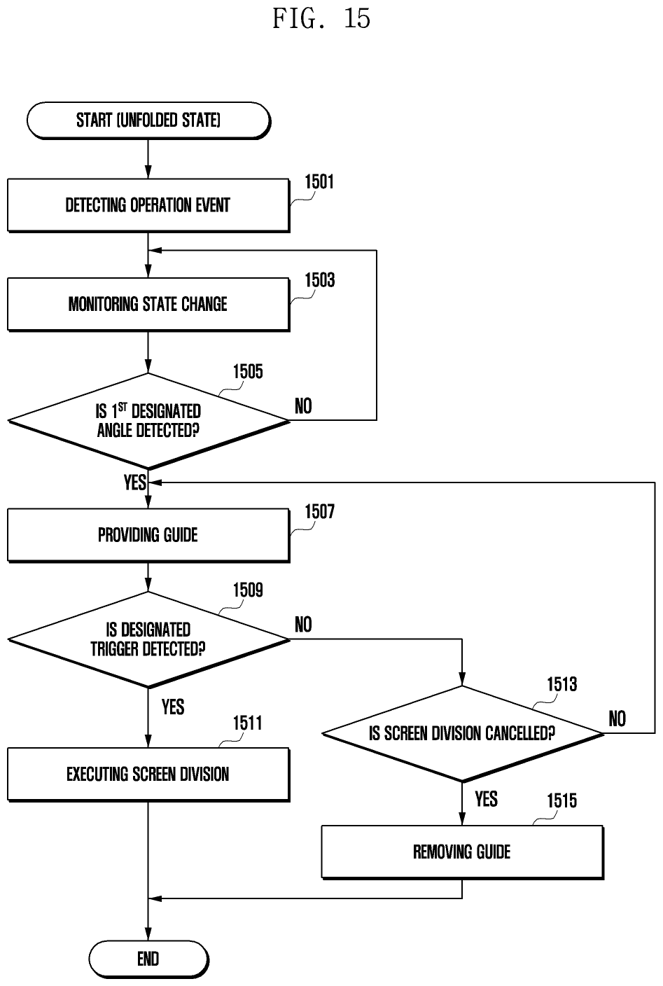

FIG. 15 is a flowchart illustrating a method of operating an electronic device according to an embodiment. More specifically FIG. 15 illustrates an operation of executing screen division when the display of the electronic device is folded from the unfolded state (e.g., a screen division method according to setting of a second method). The setting of the second method may include setting to provide a visual guide associated with screen division, e.g., when the display is switched from the unfolded state to the folded state of a first designated angle, and to execute screen division based on a designated trigger for execution of screen division (e.g., switching to a state of being folded to a second designated angle and/or a designated user interaction (or user input)). The second method may include executing screen division based on the user commands execution of screen division (e.g., the user's explicit intention (or input)). In FIG. 15, the electronic device may detect a trigger associated with screen division at a first designated angle, and may execute an action for the trigger associated with the screen division (e.g., execution of screen division) based on a designated trigger (e.g., a second designated angle or designated user input).

Referring to FIG. 15, in step 1501, a processor of the electronic device detects an operation event (or trigger) in the unfolded state of the display. For example, the processor may detect an operation event in which the state of the display is changed using at least one sensor.

In step 1503, the processor 120 monitors a state change of the display. For example, the processor may monitor a state change in which the display is folded (e.g., monitoring the change in a hinge angle) based on the operation event, and may monitor whether the state change corresponds to a designated angle (e.g., the first designated angle) for providing a guide associated with the screen division (e.g., a visual guide or a screen division guide). The processor may acquire data associated with the state change of the display from at least one sensor, and may identify the state of the display based on the acquired data.

In step 1505, the processor identifies whether the designated angle is detected (or reached). During the operation in which the display is changed from an unfolded state to a folded state, the processor may acquire data associated with the angle between the target region and the main region using at least one sensor. The processor may compare the acquired data and preset reference data, and when the acquired data corresponds to the reference data, the processor may determine that it is time to provide the visual guide. The reference data may be about N degrees, or may include an angle close thereto. The N degrees may include a predetermined angle designated (or set) by the user between 180 degrees, at which the display 210 is fully unfolded, and about 0 degrees, at which the display 210 is fully folded, such as about 3 degrees, about 5 degrees, or about 10 degrees.

When a designated angle is not detected in step 1505, the processor continues to monitor in step 1503.

However, when a designated angle is detected in step 1505, the processor provides a guide associated with screen division in step 1507. The processor may provide the visual guide associated with screen division to a user without executing screen division at the designated angle, and may perform an interaction with the user for executing screen division based on the visual guide.

In step 1509, the processor identifies whether a designated trigger is detected. While the guide for screen division is displayed, the processor may identify whether a designated trigger associated with the user's explicit intention (or input) to determine whether to execute screen division is input. The designated trigger may include a trigger in which the display is additionally folded from a designated angle (e.g., a first designated angle) and is changed by another designated angle (e.g., a second designated angle) or less, and/or a designated user interaction (or user input) input by the user based on the guide.

When a designated trigger is detected in step 1509, the processor executes screen division in step 1511. The processor may execute screen division for dividing the display into a target region and a main region based on the designated trigger, and may provide a corresponding object based on each region.

However, when a designated trigger is not detected in step 1509, the processor identifies whether cancellation of screen division is detected in step 1513. The cancellation of screen division may include first-type cancellation of completely canceling a screen division operation (e.g., not executing screen division), and second-type cancellation of maintaining the screen division operation state and waiting for detection of the designated trigger.

The first-type cancellation may include cancellation based on the explicit intention (or selection) of the user, who does not execute screen division. For example, the processor may provide a designated item (or object) for canceling screen division through a guide, and may perform the first-type cancellation based on user input on the designated item.

The second-type cancellation may include temporary cancellation, which causes the state for executing screen division to be continuously monitored when there is no user's explicit intention of not executing screen division. For example, the processor may perform the second-type cancellation when the display is changed by a designated angle or more (e.g., unfolding operation) from a designated angle (e.g., the first designated angle). When the user changes the display to the folded state, the user may select screen division based on input of a specific trigger (or interaction).

When cancellation of screen division is not detected in step 1513, the processor continues to provide the guide in step 1507.

When cancellation of screen division is detected in step 1513, the processor removes the guide in step 1515. For example, the processor may remove (or may not display) the guide provided through the display. The processor may identify a type associated with the cancellation of screen division, and in the case of the first-type cancellation, the processor may maintain the displayed state of objects on the display the positions, sizes, and/or priorities of the objects) without screen division after removing the displayed guide. The processor may identify the type associated with the cancellation of screen division, and in the case of the second-type cancellation, the processor may return to step 1503, after removing the displayed guide.

As illustrated in FIGS. 13 and 15, the automatic screen division method (e.g., FIG. 13) and the manual screen division method (e.g., FIG. 15) may be different methods. In the electronic device, one of the methods may be set (or selected) by the user, and the processor thereof may process the screen division operation based on the corresponding method set in the electronic device by the user.

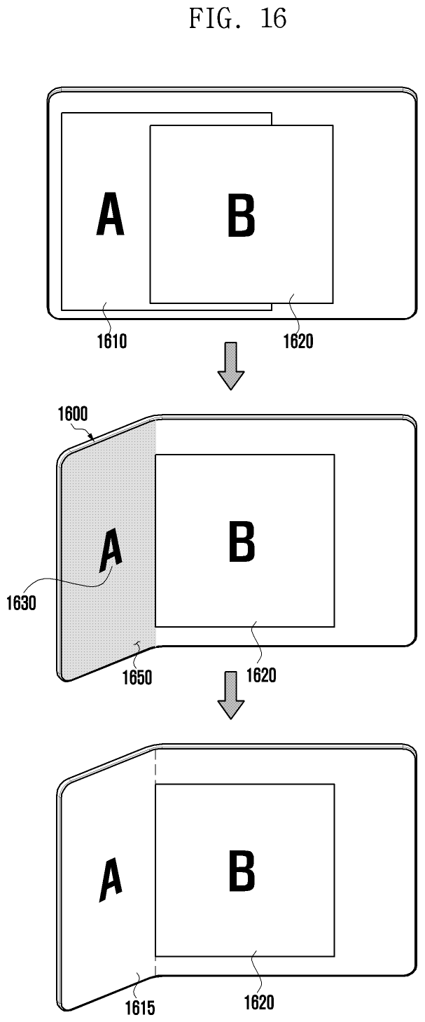

FIG. 16 illustrates executing screen division in an electronic device according to an embodiment. More specifically FIG. 16 illustrates an example in which, when at least one region (or display surface) of the display of the electronic device is folded from the unfolded state, additional folding is performed from a first designated angle (e.g., a screen division guide provision angle, and screen division is executed based on a second designated angle (e.g., a screen division execution angle).

Referring to FIG. 16, a first object 1610 and a second object 1620 are provided through the display, and the first object 1610 may be a target object to be provided through a target region 1600. The electronic device may monitor the first designated angle (e.g., N degrees) in the operation in which the target region 1600 is folded from the unfolded state of the display. Based on the time at which the target region 1600 is folded by the first designated angle, the electronic device may provide a guide 1650 associated with screen division through the target region 1600. The guide 1650 associated with screen division may include various types of visual guides, such as a first guide that graphically provides a line corresponding to a divided region (e.g., a line visual guide), a second guide that graphically provides a shape corresponding to a divided region (e.g., a shape visual guide), a third guide that graphically provides an icon (or an image (e.g., a thumbnail image)) corresponding to a target object in a divided region (e.g., an icon visual guide), and/or a fourth guide that graphically provides an image (e.g., a virtual image and/or a captured image) corresponding to a target object with a predetermined margin in a divided region (e.g., a margin visual guide).

The electronic device may monitor the second designated angle (e.g., about M degrees) in an operation in which the target region 1600 is additionally folded from the state in which the display is folded by the first designated angle. The second designated angle (e.g., about M degrees) for executing screen division is may be set to a value (or angle) smaller than the first designated angle (e.g., about N degrees) for providing a visual guide (e.g., M<N). Based on the time at which the target region 1600 is folded by the second designated angle, the electronic device may determine execution of screen division. Thereafter, the electronic device may provide the first object 1610 as a full screen 1615 through the target region 1600, and may provide the second object 1620 through the main region.

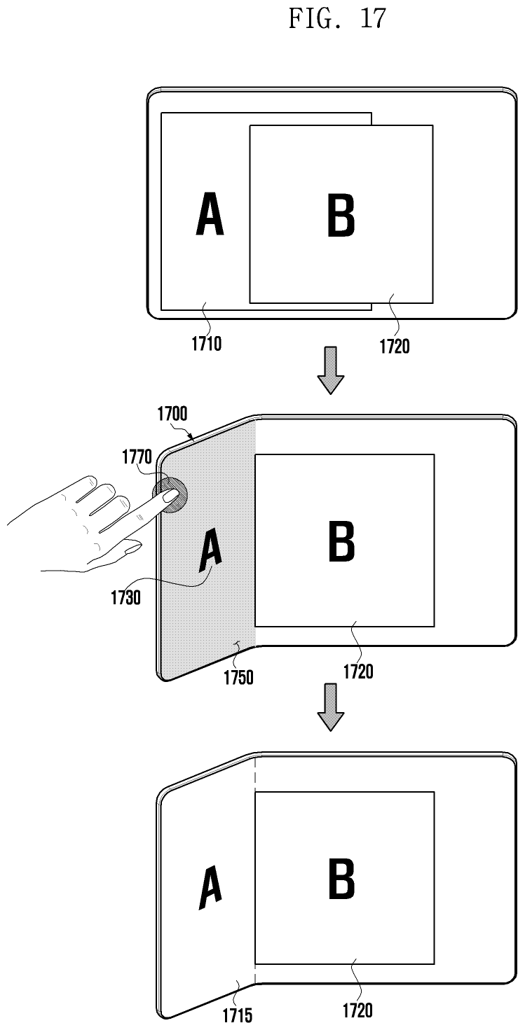

FIG. 17 illustrates executing screen division in an electronic device according to an embodiment. More specifically FIG. 17 illustrates an example in which, when at least one region (or display surface) of the display of the electronic device is folded from the unfolded state, screen division is executed based on a designated user interaction (e.g., user input) at a designated angle (e.g., a screen division guide provision angle or a screen division angle selected by the user).

Referring to FIG. 17, a first object 1710 and a second object 1720 are provided through the display, and the first object 1710 may be a target object to be provided through a target region 1700. The electronic device may monitor the designated angle (e.g., N degrees) in the operation in which the target region 1700 is folded from the unfolded state of the display. Based on the time at which the target region 1700 is folded by the designated angle, the electronic device may provide a guide 1750 associated with screen division through the target region 1700. The guide 1750 associated with screen division may include various visual guides for providing information associated with a target region and an object to be provided through the target region, such as a first guide (e.g., a line visual guide), a second guide (e.g., a shape visual guide), a third guide (e.g., an icon visual guide), and/or a fourth guide (e.g., a margin visual guide) as described above with reference to FIG. 16.

The electronic device may monitor a designated user interaction based on the target region 1700 in the state in which the display is folded by a designated angle. The designated user interaction for executing screen division may be input through the target region 1700, and may be performed through a designated type of input (e.g., touch, long touch, double tap, and/or drawing (e.g., drawing forming a closed curve)) in a designated region 1770 of the target region 1700. Based on the time at which the designated user interaction is detected through the target region 1700 and/or the time at which an additional folding operation is detected after the designated user interaction, the electronic device may determine execution of screen division. Thereafter, the electronic device may provide the first object 1710 as a full screen 1715 through the target region 1700, and may provide the second object 1720 through the main region.

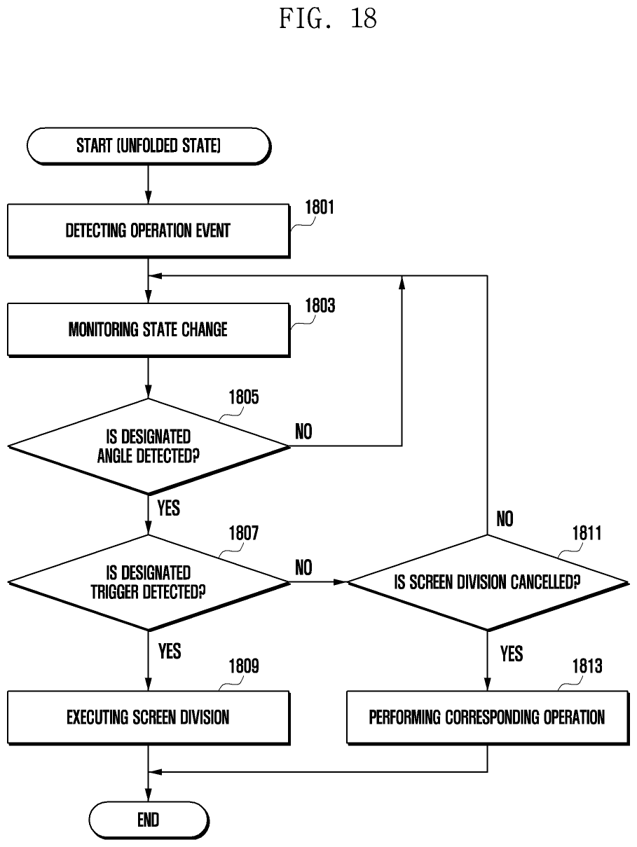

FIG. 18 is a flowchart illustrating a method of operating an electronic device according to an embodiment. More specifically, FIG. 18 illustrates an operation of executing screen division when the display of the electronic device is folded from the unfolded state a screen division method according to setting of a third method). The setting of the third method may include setting not to provide a visual guide associated with screen division, e.g., when the display is switched from the unfolded state to being folded to a designated angle, and to automatically execute screen division based on a designated trigger for execution of screen division (e.g., switching to the folded state of a second designated angle and/or a designated user interaction (or user input)). The third method may include a method of executing screen division based on the user's command to execute screen division (e.g., the user's explicit intention (or input)).

Referring to FIG. 18, in step 1801, a processor of the electronic device detects an operation event (or trigger) in the unfolded state of the display 210. The processor may detect an operation event in which the state of the display is changed using at least one sensor.

In step 1803, the processor monitors a state change of the display. The processor may monitor the state change in which the display is folded (e.g., monitoring the change in a hinge angle) based on the operation event, and may monitor whether the state change corresponds to a designated angle for executing screen division. The processor may acquire data (e.g., sensor data) associated with the state change of the display from at least one sensor, and may identify the state of the display based on the acquired data.

In step 1805, the processor identifies whether the designated angle is detected (or reached). While the display is changed from an unfolded state to a folded state, the processor may acquire data associated with the angle between the target region and the main region using at least one sensor. The processor may compare the acquired data with preset reference data (e.g., reference data for identifying a time for executing screen division or for waiting for (or standing by for) execution thereof), and when the acquired data corresponds to the reference data, the processor may determine that it is time to wait for execution of screen division. The reference data may be about N degrees, or may include an angle close thereto. The N degrees may include a predetermined angle designated (or set) by the user between 180 degrees, at which the display is fully unfolded, and about 0 degrees, at which the display is fully folded, such as about 3 degrees, about 5 degrees, or about 10 degrees.

When a designated angle is not detected in step 1805, the processor continues monitoring in step 1803.

When a designated angle is detected in step 1805), the processor identifies whether a designated trigger is detected in step 1807. The processor may not provide a guide for screen division at a designated angle, and may identify whether a designated trigger associated with the user's explicit intention (or input) to determine whether to execute screen division is input. The designated trigger may include a designated user interaction (or user input) input by the user at a designated angle of the display. The designated trigger may be input before the designated angle is detected. The user may fold the target region to a designated angle while inputting the designated trigger based on the target region.

When a designated trigger is detected in step 1807, the processor executes screen division in step 1809. The processor may execute screen division for dividing the display into a target region and a main region based on the designated angle and the designated trigger, and may provide a corresponding object based on each region.

However, when a designated trigger is not detected in step 1807, the processor identifies whether cancellation of screen division is detected in step 1811. The cancellation of screen division may include first-type cancellation of completely canceling screen division operation (e.g., not executing screen division), and second-type cancellation of maintaining the screen division standby state and waiting for detection of the designated trigger.

The first-type cancellation may include cancellation based on the explicit intention of (or selection by) the user who does not execute screen division. The processor may perform the first-type cancellation based on user input for cancellation of screen division.

The second-type cancellation may include an operation of additionally folding the display 210 in the state in which a designated trigger is not detected. When the display is folded from a designated angle without a designated trigger, the processor may perform the first-type cancellation.

The second-type cancellation may include temporary cancellation, which causes the state for executing screen division to be continuously monitored when there is no user's explicit intention of not executing screen division. The processor may perform the second-type cancellation when the display is changed by a designated angle or more (e.g., an unfolding operation) from a designated angle. When the user changes the display to the folded state, the user may select screen division based on input of a specific trigger (or interaction).

When cancellation of screen division is not detected in step 1811, the processor continues monitoring in step 1803.

When cancellation of screen division is detected in step 1811, the processor performs the corresponding operation in step 1813. The processor may cancel execution of screen division, and may maintain the displayed state of objects on the display (e.g., the positions, sizes, and/or priorities of the objects), regardless of folding/unfolding of the display.

The user-selection-based screen division method as illustrated in FIG. 18 may correspond to an operation performed based on a designated trigger without providing a guide associated with screen division at a designated angle, e.g., as illustrated in FIG. 17. The user-selection-based screen division method illustrated in FIG. 18 may be provided to the electronic device according to a user's setting (or selection), and the processor may process the screen division operation based on a corresponding method according to a setting made in the electronic device by the user.

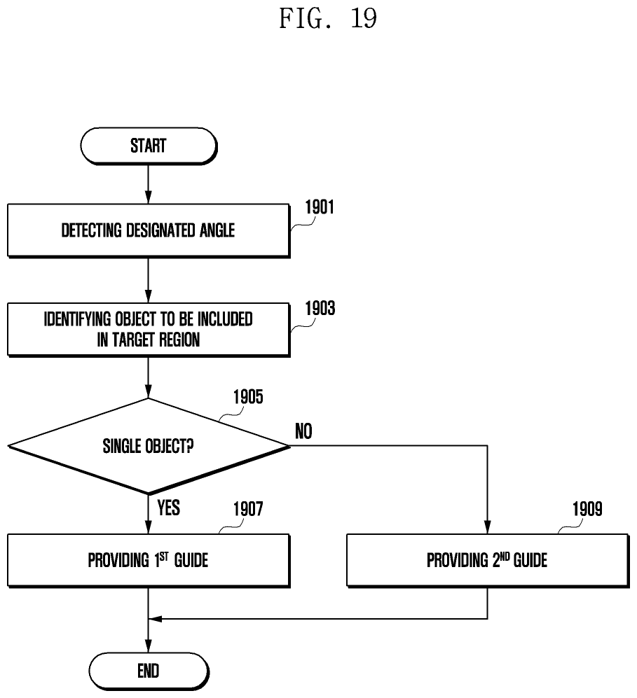

FIG. 19 is a flowchart illustrating a method of operating an electronic device according to an embodiment. Specifically, FIG. 19 illustrates providing a visual guide, in which a guide based on a single object or a guide based on multiple objects is provided based on the number of objects included in the target region of the electronic device.

Referring to FIG. 19, in step 1901, a processor of the electronic device detects a designated angle based on the folding of the display. The processor may monitor the state change of the display based on the operation event, and may identify whether the state change corresponds to a designated angle for executing screen division. The processor may acquire data (e.g., sensor data) associated with the state change of the display from at least one sensor, and may identify the state of the display based on the acquired data.

In step 1903, the processor identifies an object to be included in the target region based on detection of the designated angle. The processor may identify an object included in the target region in a range greater than or equal to a designated range as a target object to be included in the target region.

In step 1905, the processor identifies whether the object to be included in the target region corresponds to a single object or multiple objects. The processor may identify the number of objects identified as target objects to be included in the target region, and may determine whether the target object is a single object or multiple objects based on the identification result.

When the target object is a single object in step 1905, the processor provides a designated first guide through the display (e.g., a target region and/or a main region) in step 1907. The first guide may include various guides that can be provided for a single object.

When the target object is multiple objects in step 1905, the processor provides a designated second guide through the display (e.g., a target region and/or a main region) in step 1909. The second guide may be any of various guides that can be provided for multiple objects, and may include a function capable of setting (or selecting) priorities of the multiple objects.

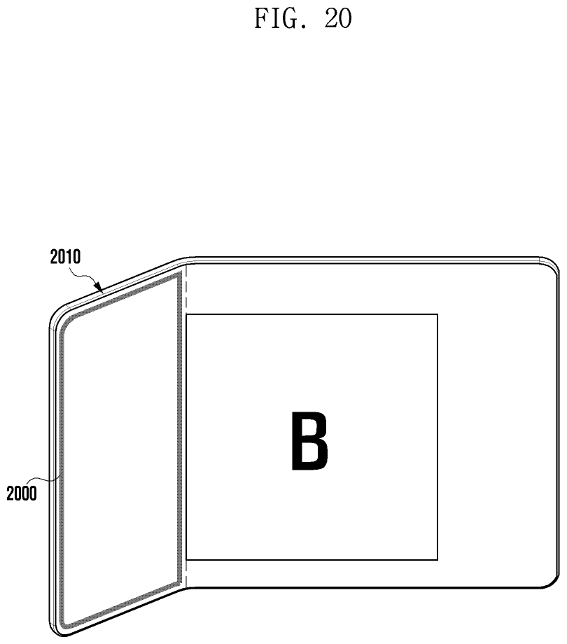

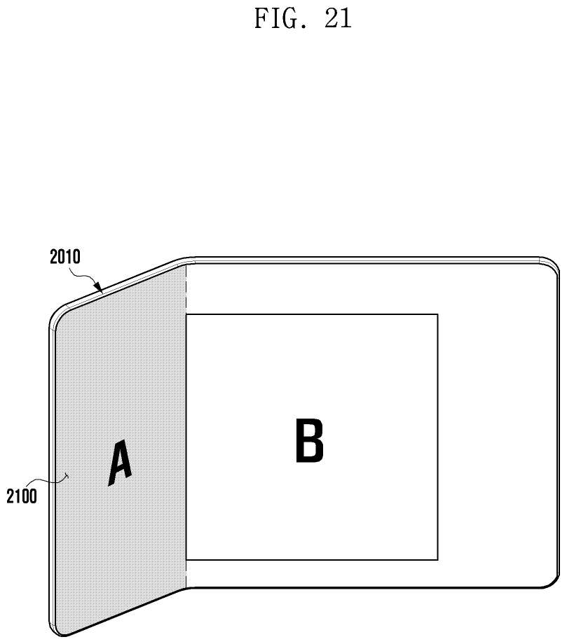

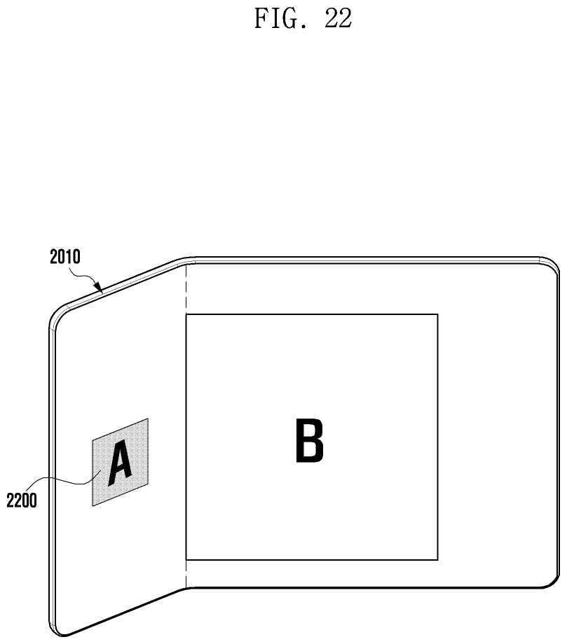

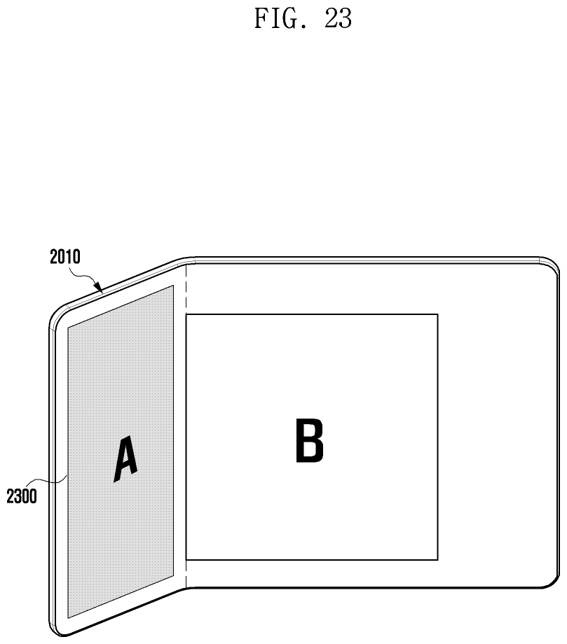

FIG. 20 illustrates a visual guide in an electronic device according to an embodiment, FIG. 21 illustrates a visual guide in an electronic device according to an embodiment, FIG. 22 illustrates a visual guide in an electronic device according to an embodiment, and FIG. 23 illustrates a visual guide in an electronic device according to an embodiment.

The electronic device may provide various guides for screen division based on an angle change (e.g., a change in a hinge angle) of the display of the electronic device. FIGS. 20, 21, 22, and 23 illustrate examples in which, when a target object to be included (or included) in a target region 2010 is a single object, a visual guide (e.g., a screen division guide) is provided to the user based on a first guide associated with the single object.

Referring to FIG. 20, a visual guide is displayed that graphically provides a line 2000 corresponding to a target object (or the window corresponding to the target object). Based on the operation in which the user folds the display (e.g., when the user bends the hinge), the electronic device may provide a visual guide for screen division to the user by displaying a line corresponding the size of a window, in which the target object is to be provided, at an edge of the target region 2010 or at a position closest to the edge through the target region 2010. The electronic device may graphically provide a line based on a designated color and/or a random color for ease of line identification by the user.

Referring to FIG. 21, a visual guide is displayed that graphically provides a shape 2100 corresponding to a target object. The electronic device may provide a visual guide for screen division to the user by displaying a UI associated with the target object, or an image having a shape corresponding thereto, through the target region 2010 based on the operation in which the user folds the display.

Referring to FIG. 22, a visual guide is displayed that graphically displays an icon 2200 (or an image (e.g., a thumbnail image)) corresponding to a target object in the target region 2010. The electronic device may provide a visual guide for screen division to the user by displaying an icon 2200 associated with the target object through the target region 2010 based on the operation in which the user folds the display.

Referring to FIG. 23, a visual guide is displayed that graphically displays an image 2300 (e.g., a virtual image and/or a captured image) corresponding to a target object with a predetermined margin in the target region 2010. The electronic device may provide a visual guide for screen division to the user by displaying a line corresponding to a window, in which a target object is to be provided and which is inwardly spaced apart from the edge of the target region 2010 by a predetermined interval, a UI associated with the target object, or an image having a shape corresponding to the UI, through the target region 2010, based on the operation in which the user folds the display.

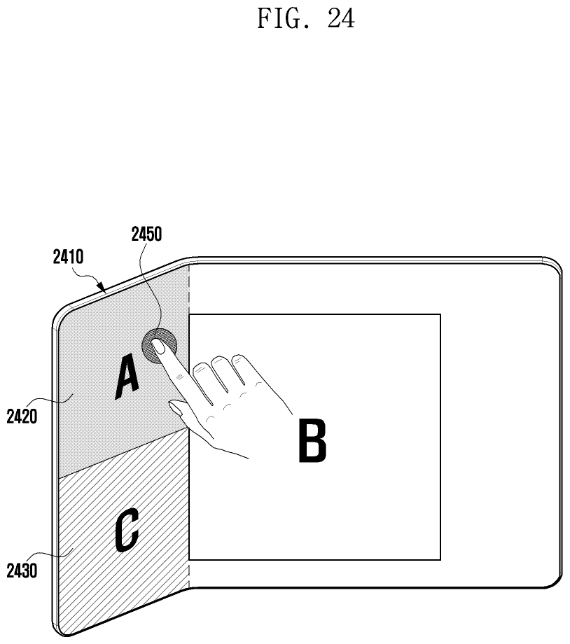

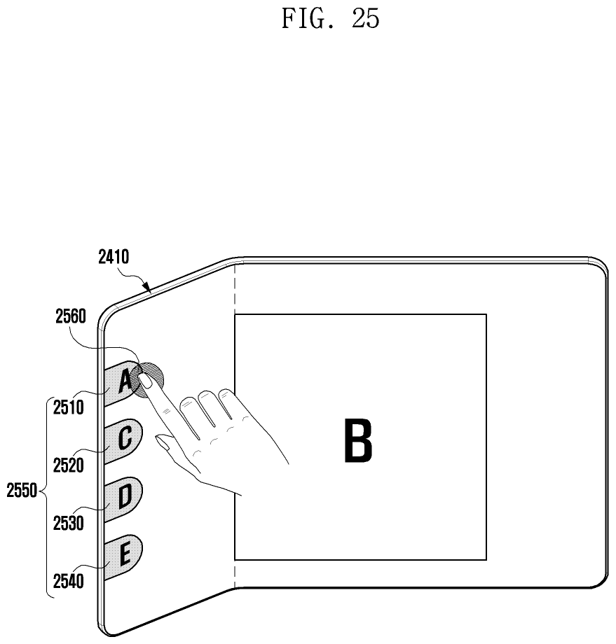

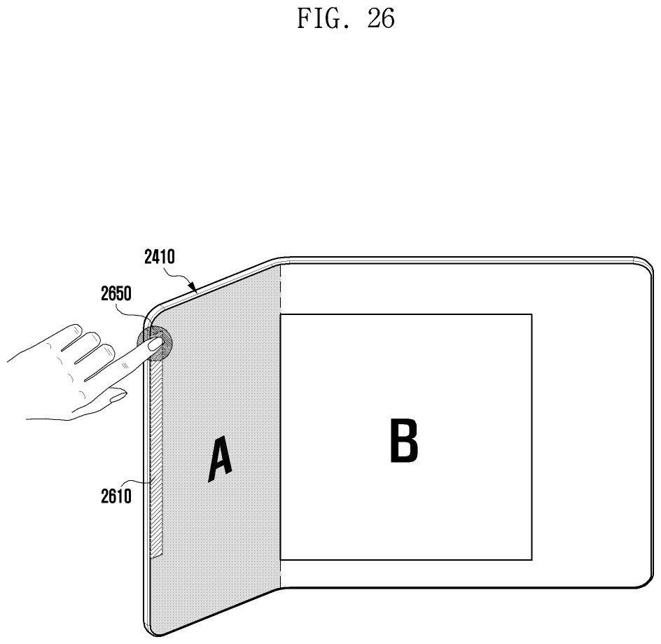

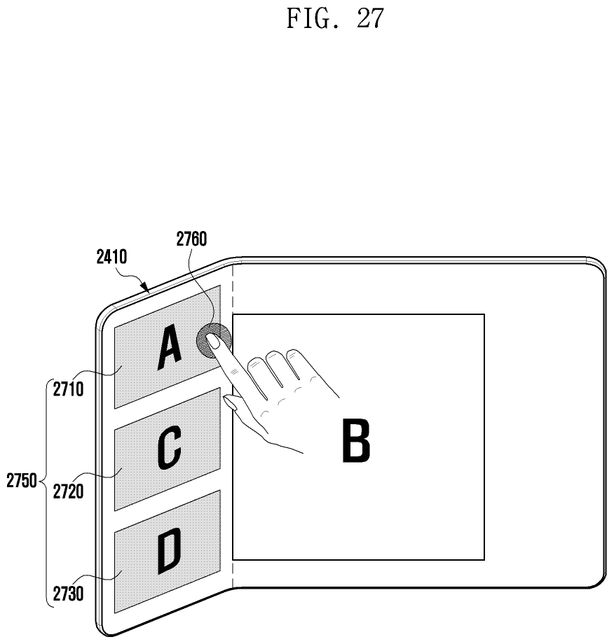

FIG. 24 illustrates a visual guide in an electronic device according to an embodiment, FIG. 25 illustrates a visual guide in an electronic device according to an embodiment, FIG. 26 illustrates a visual guide in an electronic device according to an embodiment, and FIG. 27 illustrates a visual guide in an electronic device according to an embodiment.

The electronic device may provide various guides for screen division based on an angle change (e.g., a change in a hinge angle) of the display of the electronic device. FIGS. 24, 25, 26, and 27 illustrate examples in which, when a target object to be included (or included) in the target region 2410 is multiple objects, a visual guide (e.g., a screen division guide) is provided to the user based on a second guide, which makes it possible to set priorities of the multiple objects.

Referring to FIG. 24, a visual guide is displayed, which makes it possible to set priorities of multiple objects based on windows 2420 and 2430 (e.g., lattice windows) corresponding to the number of objects to be included (or included) in the target region 2410. The electronic device may identify multiple objects to be included in the target region 2410 and/or the number thereof based on the operation in which the user folds the display (e.g., when the user bends the hinge). The electronic device may provide windows 2420 and 2430 corresponding to respective objects by performing screen division on the target region 2410 based on the number of identified objects. The electronic device may provide a visual guide, which makes it possible to select the object to be displayed with the highest priority through the target region 2410 among the multiple objects based on the windows 2420 and 2430, to the user. The user may select (e.g., touch) one of the windows 2420 and 2430 in order to set the object to be displayed with the highest priority through the target region 2410.

Referring to FIG. 25, a visual guide is displayed, which makes it possible to set priorities of multiple objects based on a list 2550 (e.g., an icon list) corresponding to the number of objects to be included (or included) in the target region 2410. The electronic device may identify multiple objects to be included in the target region 2410 and/or the number thereof based on an operation in which the user folds the display, and may generate object icons 2510, 2520, 2530, and 2540 corresponding to the multiple identified objects. The electronic device may generate a list 2550 for multiple objects based on the object icons 2510, 2520, 2530, and 2540, and may provide the list 2550 through at least one of the top, bottom, left, right, and central regions of the target region 2410. The electronic device may provide a visual guide, which makes it possible to select the object to be displayed with the highest priority through the target region 2410, among the multiple objects based on the list 2550, to the user. The user may set the object to be displayed with the highest priority through the target region 2410 by selecting (e.g., touching) one object icon 2560 in the list 2550.

Referring to FIG. 26, a visual guide is displayed, which makes it possible to set priorities of multiple objects using a scroll bar 2610 (e.g., a vertical scroll bar or a horizontal scroll bar), which makes it possible to search for multiple objects included (or to be included) in the target region 2410 based on scrolling. The electronic device may generate the scroll bar 2610, which makes it possible to scroll (e.g., to vertically scroll and/or horizontally scroll) multiple objects to be included in the target region 2410 in a scrolling manner based on the operation in which the user folds the display. The electronic device may provide the scroll bar 2610 through at least one of the top, bottom, left, right, and central regions of the target region 2410. The electronic device may provide a visual guide, which makes it possible for the user to select the object to be displayed with the highest priority through the target region 2410 among the multiple objects by searching for multiple objects using the scroll bar 2610, to the user. The user may set the object to be displayed with the highest priority through the target region 2410 by scrolling objects through input 2650 using the scroll bar 2610 and selecting one object among the multiple objects. The electronic device may provide, through the target region 2410, a previous or next object (or information about the object), which has not been visible in the target region 2410, by scrolling (e.g., vertically moving or horizontally moving) an object or information about the object displayed through the target region 2410 in response to the user's scrolling.

Referring to FIG. 27, a visual guide is displayed, which makes it possible to set priorities of multiple objects based on multiple tiles 2750 (or pop-up windows, mini windows, or tile windows) corresponding to the number of objects included (or to be included) in the target region 2410. The electronic device may identify multiple objects to be included in the target region 2410 and/or the number thereof based on an operation in which the user folds the display, and may generate multiple windows 2710, 2720, and 2730 corresponding to the multiple identified objects. The electronic device may randomly arrange and provide the multiple windows 2710, 2720, and 2730 in a tile format at random positions in the target region 2410. The multiple windows 2710, 2720, and 2730 may be arranged in order to not overlap each other, or may be arranged such that at least some of them overlap each other. The electronic device may provide a visual guide, which makes it possible to select the object to be displayed with the highest priority through the target region 2410, among the multiple objects based on the multiple tiles 2750, to the user. The user may set the object to be displayed with the highest priority through the target region 2410 by selecting (e.g., touching) one object window 2760 from the multiple tiles 2750.

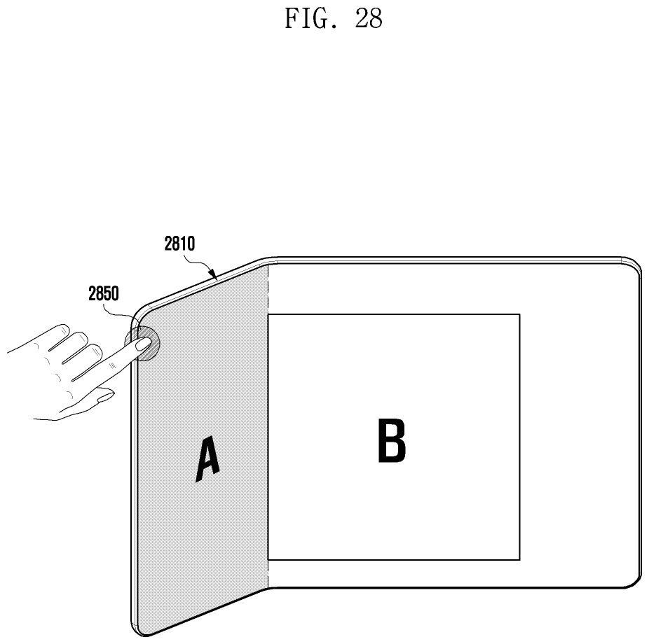

FIG. 28 illustrates canceling screen division in an electronic device according to an embodiment.

Referring to FIG. 28, while providing a visual guide for screen division, the electronic device may cancel the screen division based on receiving designated user input from the user while providing a visual guide through a target region 2810.

When a designated user input 2850 is detected in the while a visual guide is provided through the target region 2810, the electronic device may cancel the screen division. The designated user input 2850 may include input (e.g., touch) through a region designated for cancellation of the screen division in the target region 2810, input (e.g., drawing (e.g., drawing forming a closed curve), long touch, or double tap) designated for canceling screen division based on an arbitrary region of the target region 2810, or unfolding input of the display through the target region 2810. When the user input 2850 is detected while a visual guide is being provided, the electronic device may cancel screen division, and may remove the displayed visual guide based on the target region 2810. The electronic device may restore an object to an original state through the target region 2810 and the main region, and may provide the restored object.

As described above, an electronic device may be of a type in which the display is folded inwards such that the display is not exposed to the outside of the electronic device (e.g., an in-folding type). However, the various embodiments are not limited thereto, and the electronic device may be of a type in which the display is folded outwards such that the display is exposed to the outside of the electronic device (e.g., an out-folding type).

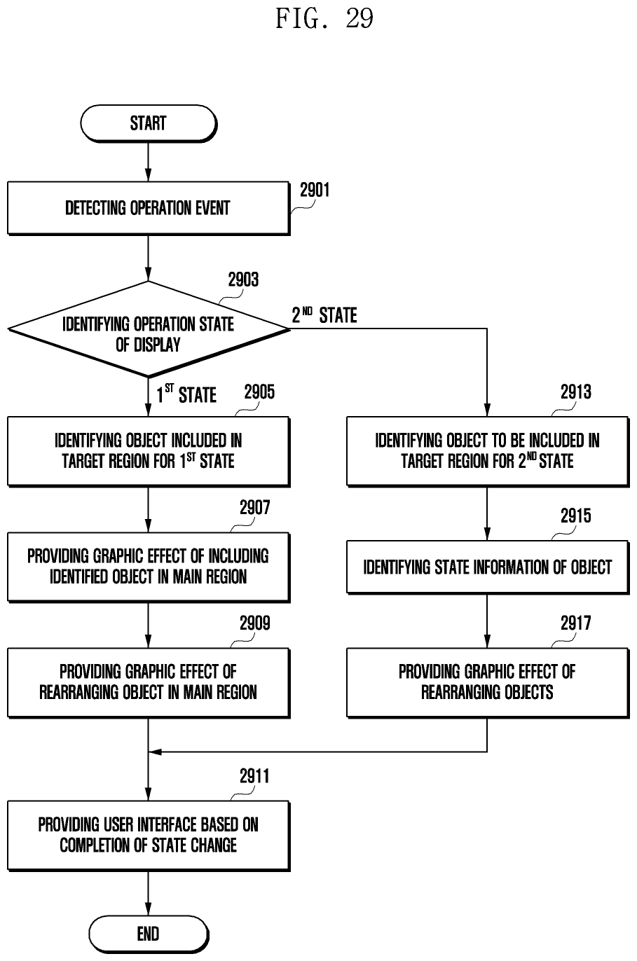

FIG. 29 is a flowchart illustrating a method of operating an electronic device according to an embodiment.

Referring to FIG. 29, in step 2901, a processor of the electronic device detects an operation event (or trigger). The processor may detect an operation event in which the state of the display is changed using at least one sensor. The states of the display may include a first state, in which the state of the display is changed from the unfolded state to a state of being folded by a designated angle, or a second state, in which the state of the display is changed from a state of being folded by a designated angle to the unfolded state.

In step 2903, the processor identifies the operation state of the display. For example, when the operation event in which the state of the display is changed is detected, the processor determines whether the state of the display is the first state or the second state. The processor may acquire data (e.g., sensor data) associated with the state change of the display from at least one sensor, and may identify the state of the display based on the acquired data. The at least one sensor may include a sensor (e.g., a smart hall sensor) that determines the state (e.g., the folded state or the unfolded state) of the electronic device (or a display of the electronic device), and/or a sensor (e.g., an acceleration sensor or a gyro sensor) that determines the rotation and orientation of the electronic device. The at least one sensor may include at least one of a touch sensor and a pressure sensor.

In response to identifying the first state in step 2903, the processor identifies at least one object having at least one partial region included in the target region according to the first state (e.g., a folded region, among the regions of the display) in step 2905. The processor may execute an operation of identifying an area folded in a designated range and identifying the area folded in the designated range as a target region (or a target display surface); an operation of identifying an object including at least one partial region included in the target region as a target object; an operation of identifying state information (e.g., restoration positions, restoration sizes, and/or a display (or arrangement) order (or a priority)) related to (or corresponding to) objects in the target region and the main region; an operation of storing the identified state information in memory; an operation of deactivating the target region; and/or an operation of identifying an operation time associated with folding.

The operation of deactivating the target region may include an operation of determining the target region as an unused display surface, and cutting off power to the display surface so as to turn off the display surface. The operation time associated with unfolding may be identified based on the folding angle of the display. During the operation in which the electronic device is changed from a fully unfolded state (e.g., an unfolded state) to a folded state, the processor may acquire data (e.g., detected data) associated with the angle between the first region (or the first display surface) of the first portion of the housing and the second region (or the second display surface) of the second portion of the housing using at least one sensor. The processor may compare the acquired data and preset first reference data (e.g., reference data for identifying a first operation time at which the second state is changed to the first state), and when the acquired data corresponds to the first reference data, the processor may determine that it is time to execute screen division of the display.

In step 2907, the processor provides a graphic effect including (e.g., moving and/or size-adjusting) the identified object in the main region based on the detection of the first state change of the display. The processor may provide a graphic effect of moving the identified object to the main region and displaying the object by adjusting the size of the object (or the window size) according to a setting.

In step 2909, the processor provides a graphic effect of rearranging and displaying an object through the main region based on the detection of the first state change of the display. The processor may provide a graphic effect of moving the object of the target region into the main region (e.g., moving the object having at least one partial region included in the target region (and/or located over the target region) into the main region), adjusting the size (e.g., resizing) of the object (or the window size), and causing the object to be displayed in the main region according to a designated priority (e.g., maintaining the priorities of the objects).

Alternatively, steps 2907 and 2909 may be performed sequentially, in parallel (or almost simultaneously), or in the reverse order.

In step 2911, the processor provides (e.g., display) a UI based on completion of the state change. The processor may provide a first UI of at least one first object in the target region and a second UI of at least one second object in the main region in the state of being arranged (e.g., overlapped) in the main region according to designated priorities thereof.

The processor may provide objects in the main region in different ways depending on the operating method of the display set in the electronic device. The processor may provide the object having the highest priority in the main region as a full screen based on a first designated method, or may provide the object by maintaining the existing form (e.g., based on a pop-up window) and changing the arrangement according to the priority thereof based on a second designated method. When providing the UI of each object, the processor may identify the order of objects to be displayed based on the priority of each object. Based on the identified priority of each object, the processor may set the UI of the object having the highest priority as the highest level, and may provide UIs of other objects in the sequentially overlapping state.

The processor may provide a first object, which has been displayed at the highest level in the target region, and a second object, which has been displayed at the highest level in the main region, but when the UI of the first object and the UI of the second object overlap each other, the processor may assign a weight to the first object of the target region and may provide the UI of the first object such that the UI of the second object overlaps the UI of the first object at a higher level than the UI of the second object. Objects other than the first object and the second object may be sequentially disposed on layers under the UI of the first object and/or the UI of the second object according to the positions and/or priorities thereof.

Based on the determination of the second state in step 2903, the processor identifies an object to be included in the target region according to the second state (e.g., an unfolded region, among the regions of the display) in step 2913. The processor may perform an operation of identifying an unfolded region and identifying the unfolded region as a target region (or a target display surface), an operation of activating the target region, an operation of identifying at least one object to be included in the target region, and/or an operation of identifying an operation time associated with unfolding.

The operation of activating the target region may include an operation of determining, e.g., the target region as a reused display surface, and supplying power to the display surface so as to turn on the display surface. The operation time associated with folding may be identified based on the unfolding angle of the display. While the electronic device is changed from a folded state to an unfolded state, the processor may acquire data associated with the angle between the first region (or the first display surface) of the first portion of the housing and the second region (or the second display surface) of the second portion of the housing using at least one sensor. The processor may compare the acquired data with preset second reference data (e.g., reference data for identifying a second operation time at which the first state is changed to the second state), and when the acquired data corresponds to the second reference data, the processor may determine that it is time to execute screen integration (e.g., to cancel screen division) of the display.

In step 2915, the processor identifies state information associated with restoration of an object to a previous state. The processor may identify state information (e.g., restoration positions, restoration sizes, and/or a display order (or a priority)) associated with (or corresponding to) the objects in the target region and the main region. The state information for restoration to the previous state may be information that is identified when the display changes to the first state and is stored in a memory.

In step 2917, the processor provides a graphic effect of rearranging objects. Based on state information corresponding to the object, the processor may identify the restoration position, restoration size, and/or overlapping state (or display order) of each object based on position information, the processor may move the position of at least one object based on size information, the processor may restore the size of the at least one object (e.g., the window size) to the previous size (e.g., based on a pop-up window), and, based on priority information (e.g., overlapping state), the processor may provide a graphic effect of overlapping objects.

The processor may provide each corresponding to each object in the previous state based on the unfolded target region and the main region. The processor may provide a UI of each object in the state before folding (e.g., based on the full window and/or based on a pop-up window) based on the restoration position of each object. When providing the U1 of each object, the processor may identify the order of the objects to be displayed based on the priority of each object. Based on the identified priority of each object, the processor may set the UI of the object having the highest priority as the highest level, and may provide UIs of other objects in the sequentially overlapping state.

In step 2911, the processor provides (e.g., displays) a UI based on the completion of the state change. The processor may restore the UI of each object to the state before folding and provide the same in a full screen in which the target region and the main region are connected as a single screen.

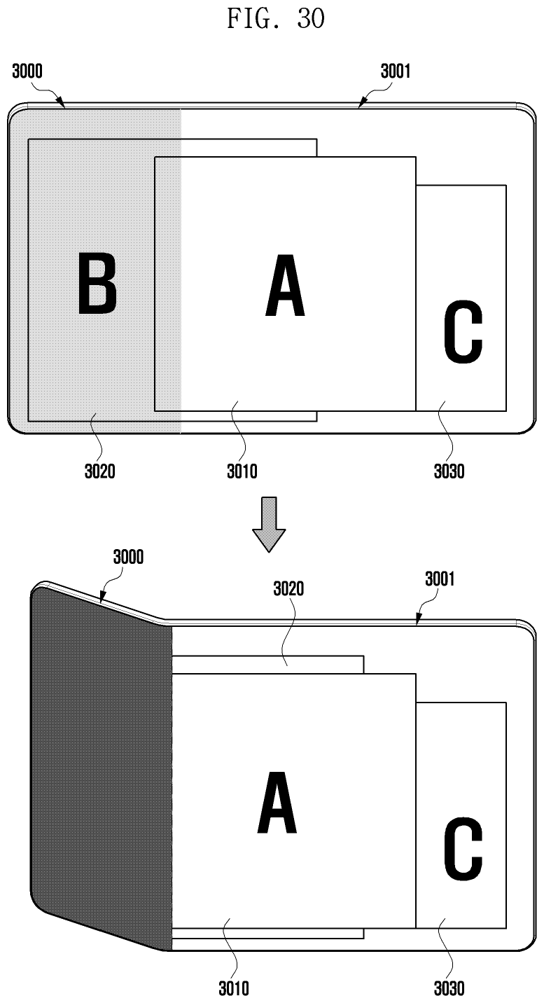

FIG. 30 illustrates operation of a display in an electronic device according to an embodiment. Specifically, FIG. 30 illustrates an example in which, in an operation of folding (e.g., out folding) at least one region (or a display surface), an object included in the folded region (e.g., a target region 3000 as an unused region) is provided while being moved to a fixed region (e.g., a main region 3001).

Referring to FIG. 30, when portions of objects 3010 and 3020 are included in the target region 3000, the object 3020 included in the target region 3000 in a range that is greater than or equal to a designated range is determined to be a target object to be moved to the main region 3001, and is moved to the main region 3001. The first object 3010 and the second object 3020 are at least partially included in the target region 3000 and a third object 3030 is not included in the target region 3000. The first object 3010 is included in the target region in a range less than a designated region, the second object 3020 is included in the target region 3000 in a range greater than or equal to the designated range, and the third object 3030 is not included in the target region 3000, but is included in the main region 3001.

The electronic device may process the target region 3000 as an unused region (e.g., an inactive region) based on an operation event (e.g., a deactivation process), and may identify a target object to be moved to the main region 3001 among one or more objects included in the target region 3000.

Among the first object 3010 and the second object 3020 included in the target region 3000, the electronic device may determine the second object included, in the target region 3000 in a range greater than or equal to the designated range to be the target object to be moved to the main region 3001, and may provide the second object 3020 in the state of being moved to the main region 3001. The electronic device may not move the first object 3010 included in the target region 3000 in a range less than the designated range to the main region 3001.

The electronic device may identify an object included in the target region 3000 in a range greater than or equal to the designated range to be a target object to be moved to the main region 3001, and the first object 3010 may not be included in the target object, e.g., as illustrated in FIG. 10.

The electronic device may maintain the displayed state of the first object 3010 and the third object 3030 through the main region 3001. The electronic device may provide the first object 3010, the second object 3020, and the third object 3030 in the main region 3001 in the state in which the priorities thereof are maintained. The electronic device may provide the object having the highest priority (e.g., the first object 3010) as a full screen in the main region 3001.

Regardless of the included ranges of the first object 3010 and the second object 3020, which are included in the target range 3000, the electronic device may determine all of the objects which are at least partially included in the target region 3000 (e.g., the first object 3010 and the second object 3020) as target objects to be moved to the main region 3001, and may provide the first object 3010 and the second object 3020 in the state of having been moved into the main region 3001.

When at least a portion of a target is included in the target region 3000 and at least another portion of the target is included in the main region 3001 in a range greater than or equal to a designated range, like the first object 3010 and the second object 3020, the electronic device may not move the target object. For example, the electronic device may provide the window of the target object in the state of being resized (e.g., reduced) with reference to a folding surface (or a folding axis or a hinge axis) between the target region 3000 and the main region 3001. For example, the electronic device may fix and set a first portion included in the main region 3001, among the portions of the target object, as a reference point, and may provide the window of the target object in the state of being reduced in size by an amount corresponding to the interval between the portions included in the target region 3000.

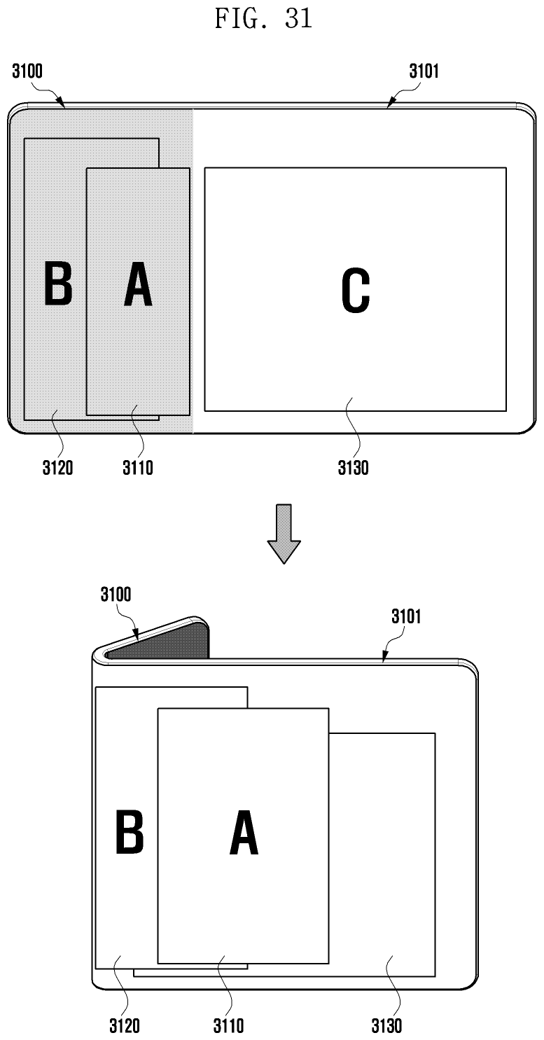

FIG. 31 illustrates operation of a display in an electronic device according to an embodiment. Specifically, FIG. 31 illustrates an example in which, in an operation of folding (e.g., out-folding) at least one region (or a display surface) in the state in which the electronic device is unfolded, an object included in the folded region (e.g., a target region 3100 as an unused region) is provided while being moved to a fixed region (e.g., a main region 3001).

Referring to FIG. 3 when all the portions of the objects 3110 and 3120 are included in the target region 3100, the objects 3010 and 3020 included in the target region 3100 as target objects to be moved to the main region 3101, and the target objects 3010 and 3020 are moved while maintaining the priorities thereof (e.g., the object 3110 located at the highest level in the target region 3100 has the highest priority).

For example, all portions of the first object 3110 and the second object 3120 may be included in the target region 3100. When all portions of the first object 3110 and the second object 3120 are included in the target region 3100, the electronic device may assign the highest priority to the first object 3110 provided at the highest level among the first object 3110 and the second object 3120, which overlap in the target region 3100. The electronic device may provide the first object 3110 at the highest level through the main region 3101, and may sequentially arrange other objects 3120 and 3130 on the layers under the first object 3110 according to the positions and/or priorities thereof.

The electronic device may process the target region 3100 as an unused region (e.g., an inactive region) based on an operation event (e.g., a deactivation process), and may determine the objects 3110 and 3120 included in the target region 3100 as target objects. Thereafter, the electronic device may provide the target objects 3110 and 3120 while being moved to the main region 3101. The electronic device may provide the third object 3130 included in the main region 3101 in the state in which the position, size, and/or priority thereof in the main region 3101 are maintained.

The electronic device may identify priorities of the first object 3110, the second object 3120, and the third object 3130 based on the movement of the target objects 3110 and 3120 to the main region 3101. The electronic device may provide the first object 3110, the second object 3120, and the third object 3130 in the state of being sequentially arranged in the main region 3001 based on the priorities thereof. In FIG. 31, the first object 3110 of the target region 3100 has the highest priority, the second object 3120 and the third object 3130 are provided in the state of being covered by the first object 3110, and the second object 3120 and the third object 3130 are sequentially arranged in the layers under the first object 3110 according to the priorities thereof. The electronic device may provide the object having the highest priority (e.g., the first object 3110) as a full screen in the main region 3101.

The electronic device may provide the first object 3110, which has been displayed at the highest level in the target region 3100, and the third object 3130, which has been displayed at the highest level in the main region 3101, at the highest level. However, when the first object 3110 and the third object 3130 overlap each other, a weight may be assigned to the first object 3110, and the first object 3110 and the third object 3130 may be provided in the state in which the first object 3110 overlaps the third object 3130 at a higher level.

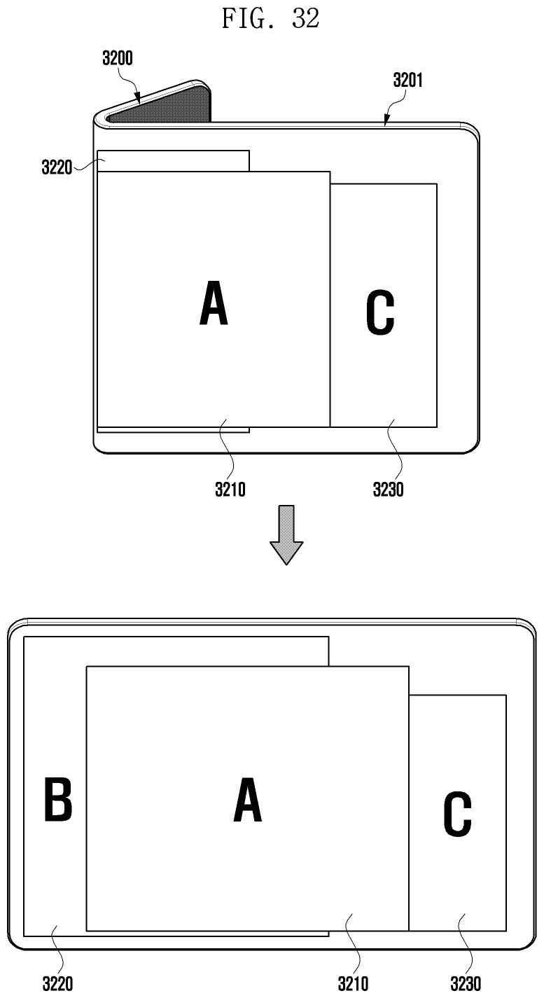

FIG. 32 illustrates operation of a display in an electronic device according to an embodiment. Specifically, FIG. 32 illustrates an example in which, in an operation of changing at least one region to an unfolded state from the state in which the at least one region (or a display surface) of the display has been folded in a designated range (e.g., the state in which screen division has been performed), an object to be included in the unfolded region (e.g., the target region 3200) and an object to be included in a fixed region (e.g., the main region 3201) are restored to the original state, and UIs for the objects are provided.

Referring to FIG. 32, a first object 3210, a second object 3220, and a third object 3230 are provided in the main region 3201, and one or more objects (e.g., the first object 3210 and the second object 3220) of the main region 3201 are restored based on the original positions, sizes, and priorities thereof according to the unfolding operation of the display. The first object 3210, the second object 3220, and the third object 3230 are in an overlapping state in the main region 3201, and the first object 3210, the second object 3220, and the third object 3230 have higher priorities in that order. When there is no change in the state information the positions, the sizes, and/or the priorities) of respective objects 3210, 3220, and 3230 during the switching from the folded state to the state unfolded in a designated range, the electronic device may restore respective objects 3210, 3220, and 3230 to the previous state in order to provide the restored objects 3210, 3220, and 3230.

The electronic device may process the target region 3200 as a used region (e.g., an active region) based on an operation event (e.g., an activating process), and may identify a target object to be displayed through the target region 3200 among one or more objects included in the main region 3201.

The electronic device may identify the positions, sizes, and/or priorities of the first object 3210, the second object 3220, and the third object 3230 of the main region 3201. Based on the positions, sizes, and/or priorities of respective objects 3210, 3220, and 3230, the electronic device may move the first object 3210 and the second object 3220 of the main region 3200 to the original positions based on the target region 3200 and the main region 3201, and the electronic device may provide the first object 3210 at the highest level according to the priority thereof and may sequentially arrange the second object 3220 and the third object 3230 under the first object 3210 according to the priorities thereof.

When there is a change in state information related to at least one of the objects 3210, 3220, and 3230 in the state of being folded within the designated range, the electronic device may arrange the first object 3210, the second object 3220, and the third object 3230 and may arrange the same based on the changed state information. For example, when the folded state in the designated range is changed to the unfolded state while the user selects the third object 3230 of the main region 3205 and uses the third object 3230 at the highest level, the electronic device 101 may provide the third object 3230 at the highest level based on the changed priority thereof, and may sequentially arrange the first object 3210 and the second object 3220 under the third object 3230 according to the priorities thereof.

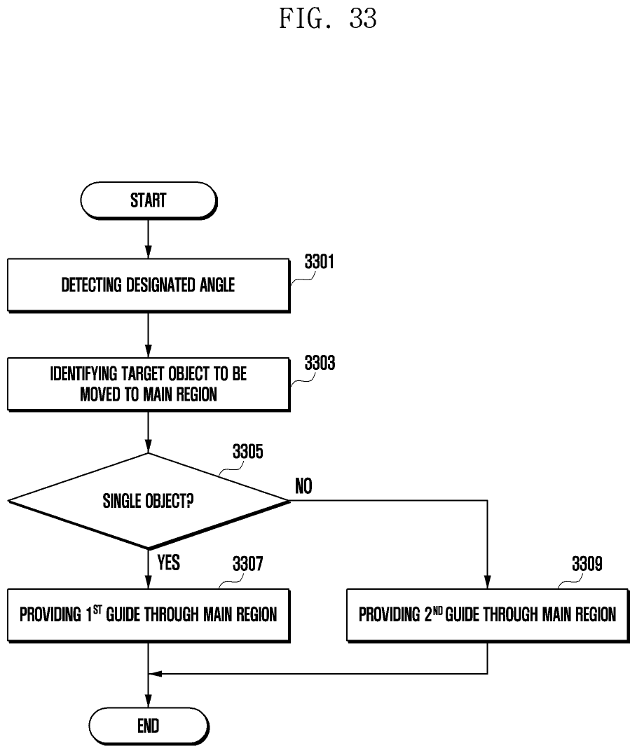

FIG. 33 is a flowchart illustrating a method of operating an electronic device according to an embodiment. Specifically, FIG. 33 illustrates a method of providing a visual guide, in which a guide based on a single object or a guide based on multiple objects is provided based on the number of target objects of the electronic device.

Referring to FIG. 33, in step 3301, a processor of the electronic device detects a designated angle based on the folding of the display. The processor may monitor the state change of the display based on the operation event, and may identify whether the state change corresponds to a designated angle for executing screen division. The processor may acquire data associated with the state change of the display from at least one sensor, and may identify the state of the display based on the acquired data.

In step 3303, the processor identifies a target object to be moved to the main region based on detection of the designated angle. The processor may identify an object included in the target region in a range greater than or equal to a designated range or at least partially included in the target region as a target object to be moved from the target region to the main region.

In step 3305, the processor identifies whether the target object corresponds to a single object or multiple objects. The processor may identify the number of objects identified as target objects to be moved to the main region, and may determine whether the target object is a single object or multiple objects based on the identification result.

When the target object is a single object in step 3305, the processor provides a designated first guide through the display (e.g., the main region) in step 3307. The processor may process the target area as an unused area (e.g., an inactive region) (e.g., a deactivation process), and may provide a designated visual guide based on the main region. The first guide may include various guides that can be provided for a single object.

When the target object is multiple objects in step 3305, the processor provides a designated second guide through the display (e.g., a main region) in step 3309. The processor may process the target area as an unused area (e.g., an inactive region) (e.g., a deactivation process), and may provide a designated visual guide based on the main region. The second guide may be various guides that can be provided for multiple objects, and may include a function of setting (or selecting) at least one object to be moved to the main region, among the multiple target objects, and/or a function of setting (or selecting) priorities of the multiple objects.

When setting the priorities based on a visual guide, the objects for which a priority is to be set may include all objects in the target region and the main region. In this case, in step 3305, the processor may identify the target object and all objects in the target area and the main region, in order to identify whether there are multiple objects.

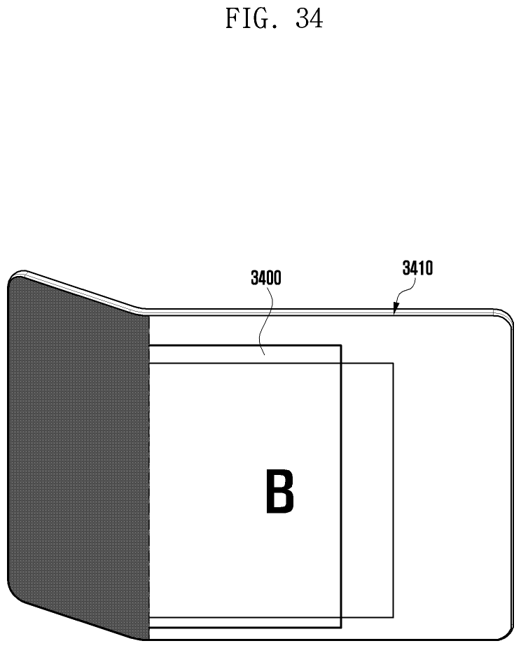

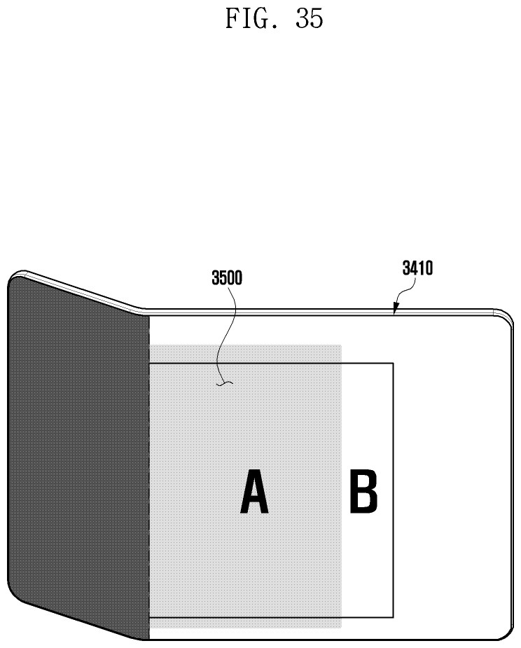

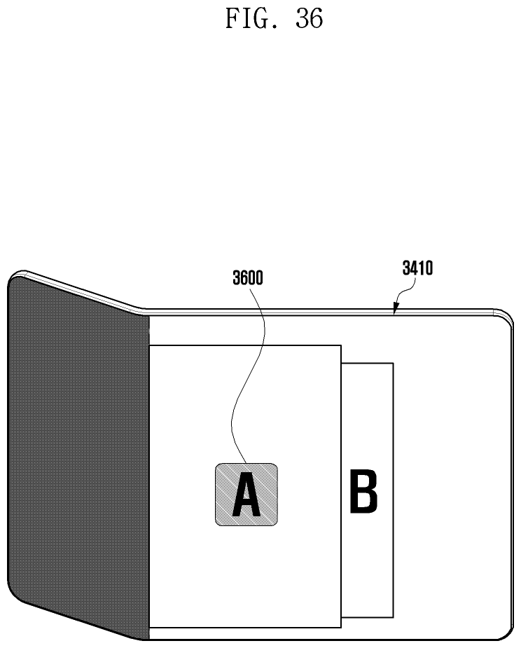

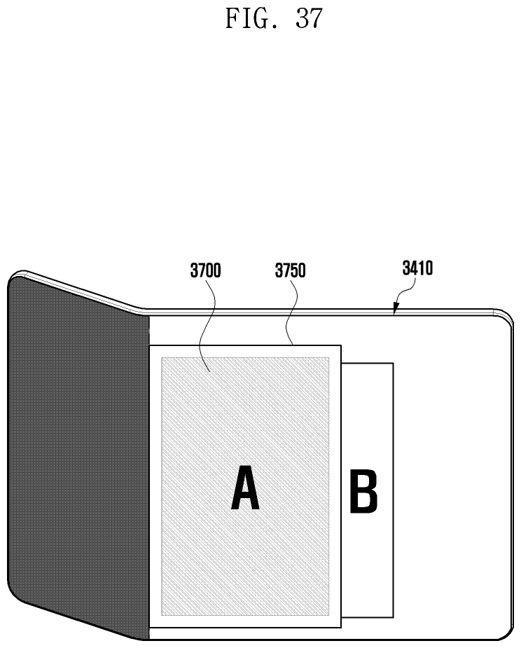

FIG. 34 illustrates a visual guide in an electronic device according to an embodiment, FIG. 35 illustrates a visual guide in an electronic device according to an embodiment, FIG. 36 illustrates a visual guide in an electronic device according to an embodiment, and FIG. 37 illustrates a visual guide in an electronic device according to an embodiment.

The electronic device may provide various guides for screen division based on an angle change (e.g., a change in a hinge angle) of the display of the electronic device. FIGS. 34, 35, 36, and 37 illustrate examples in which, when a target object to be included in (or to be moved to) the main region 3410 from the target region is a single object, a visual guide (e.g., a screen division guide) is provided to the user based on a first guide associated with the single object.

Referring to FIG. 34, a visual guide is displayed that graphically provides a line 3400 corresponding to a target object (or the window of the target object). Based on an operation in which the user folds the display (e.g., when the user bends the hinge), the electronic device may provide a visual guide for screen division to the user by displaying a line corresponding the size of the window in which the target object is to be provided, on a folded surface between the target region and the main region 3410 or at a position closest to the folded surface through the main region 3410. The electronic device may graphically provide a line based on a designated color and/or a random color for ease of line identification by the user. When a line visual guide is provided, the electronic device may provide only a line (e.g., a border line) corresponding to the region occupied by a target object, and the inside of the line may be provided to be transparent such that an object included in the main region 3410 is visible therethrough and thus displayed.

Referring to FIG. 35, a visual guide is displayed that graphically provides a shape 3500 corresponding to a target object. The electronic device may provide a visual guide for screen division to the user by displaying a UI associated with the target object or an image having a shape corresponding thereto, through the main region 3410 based on the operation in which the user folds the display.

Referring to FIG. 36, a visual guide is displayed that graphically displays an icon 3600 (or an image (e.g., a thumbnail image)) corresponding to a target object. The electronic device may provide a visual guide for screen division to the user by displaying an icon 3600 associated with the target object through the main region 3410 based on the operation in which the user folds the display. When providing an icon visual guide, the electronic device may provide only an icon 3600 associated with the target object on the main region 3410 or an object in the main region 3410. Alternatively, a region occupied by the target object may be drawn, and the icon 3600 associated with the target object may be provided in the drawn region.

Referring to FIG. 37 a visual guide is displayed that graphically displays an image 3700 (e.g., a virtual image and/or a captured image) corresponding to a target object with a predetermined margin in a region 3750 occupied by a target object. The electronic device may provide a visual guide for screen division to the user by displaying a line corresponding to a window in which a target object is to be provided and which is inwardly spaced apart from the edge of the region occupied by the target object by a predetermined interval, a UI associated with the target object, or an image having a shape corresponding to the UI, through the main region 3410 based on the operation in which the user folds the display.

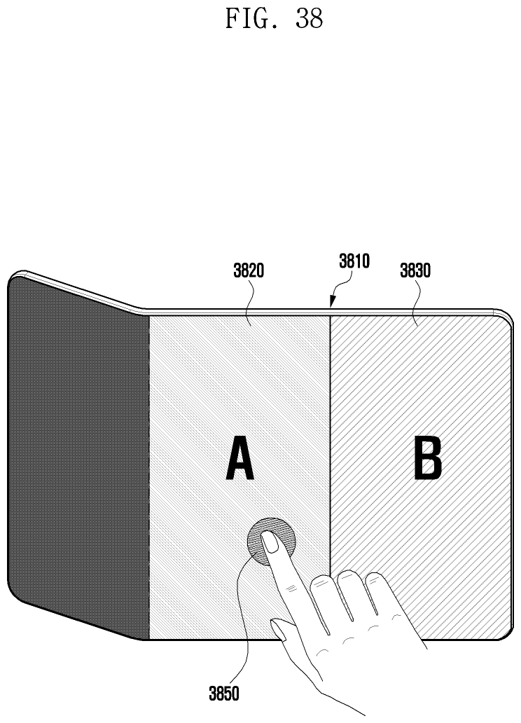

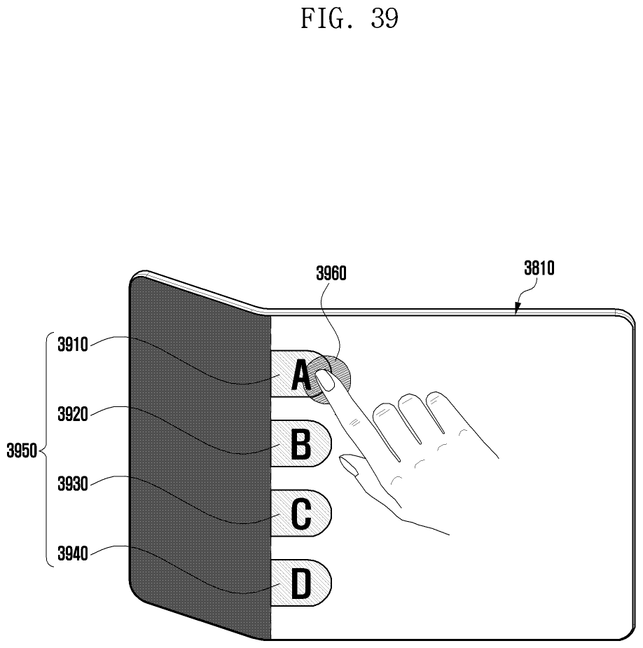

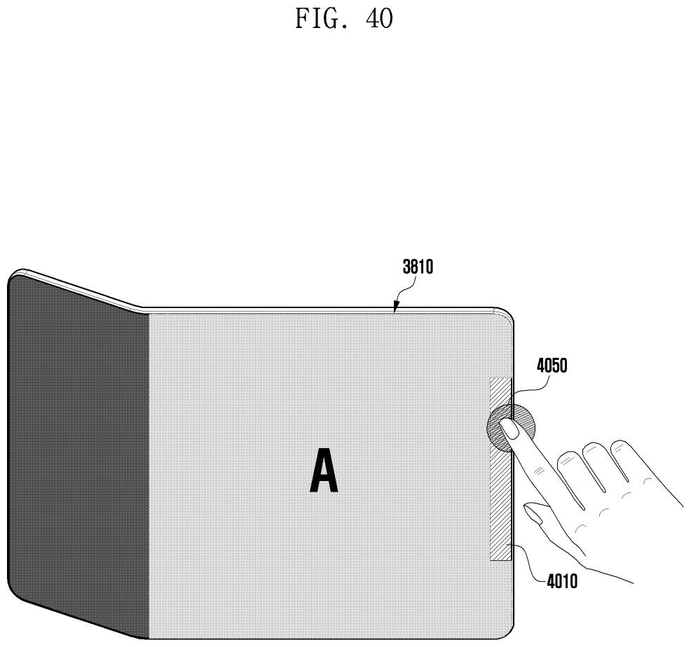

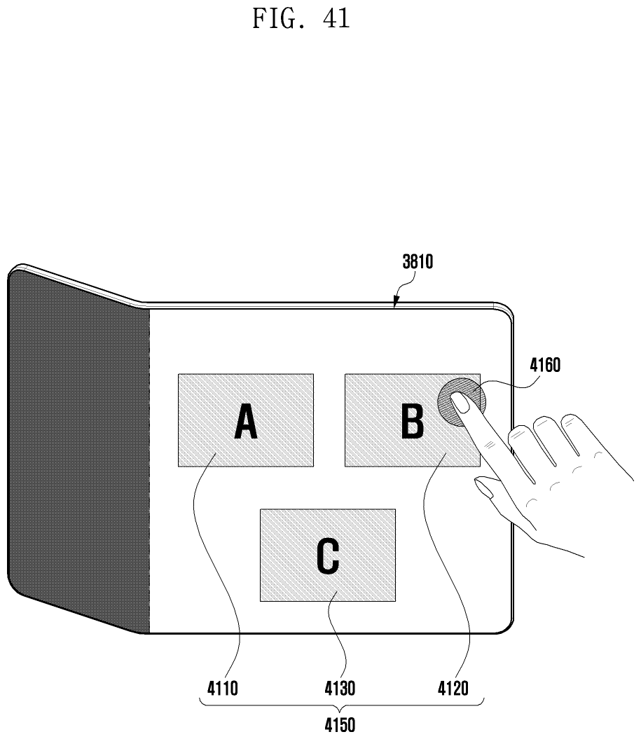

FIG. 38 illustrates a visual guide in an electronic device according to an embodiment, FIG. 39 illustrates a visual guide in an electronic device according to an embodiment, FIG. 40 illustrates a visual guide in an electronic device according to an embodiment, and FIG. 41 illustrates a visual guide in an electronic device according to an embodiment.

The electronic device may provide various guides for screen division based on an angle change (e.g., a change in a hinge angle) of the display of the electronic device. FIGS. 38, 39, 40, and 41 illustrate examples in which, when a target object to be included in (or to be moved to) a main region 3810 is multiple objects, a visual guide (e.g., a screen division guide) is provided to the user based on a second guide, which makes it possible to set priorities of the multiple objects and/or at least one target object to be moved to the main region 3810, among the multiple objects. FIGS. 38, 39, 40, and 41 illustrate an example in which, based on the second guide, at least one target object to be moved to the main region 3810 is set, among the multiple objects identified based on the target region.

When setting the priorities based on a visual guide (e.g., the second guide), the objects for priority setting may include all objects of the target region and the main region. For example, in setting the priorities of objects displayed through the main region 3810, the electronic device may provide all the objects of the target region and the main region so that the user can set the priorities.

Referring to FIG. 38, a visual guide is displayed that makes it possible to set a target object to be moved to a main region 3810 among the multiple objects based on windows 3820 and 3830 (e.g., lattice windows) corresponding to the number of target objects. The electronic device may identify multiple objects to be moved to the main region 3810 and/or the number thereof based on the operation in which the user folds the display 210 (e.g., when the user bends the hinge). The electronic device may provide windows 3820 and 3830 corresponding to respective objects by performing screen division on the main region 3810 based on the number of identified objects. The electronic device may provide a visual guide, which makes it possible to select an object to be moved to the main region 3810 (or to be displayed with the highest priority through the main region 3810) among the multiple objects based on the windows 3820 and 3830, to the user. The user may select (3850) (e.g., touch) at least one of the windows 3820 and 3830 in order to set at least one object to be moved to the main region 3810.

Referring to FIG. 39, a visual guide is displayed, which makes it possible to set a target object to be moved to the main region 3810, among multiple objects based on a list 3950 (e.g., an icon list) corresponding to the number of target objects. The electronic device 101 may identify multiple objects to be moved to the main region 3810 and/or the number thereof based on an operation in which the user folds the display, and may generate object icons 3910, 3920, 3930, and 3940 corresponding to the multiple identified objects. The electronic device may generate a list 3950 for multiple objects based on the object icons 3910. 3920, 3930, and 3940, and may provide the list 3950 through at least one of the top, bottom, left, right, and central regions of the main region 3810.

The electronic device may provide a visual guide that makes it possible to select an object to be moved to the main region 3810 (or to be displayed with the highest priority through the main region 3810), among the multiple objects based on the list 3950, to the user. The user may select (e.g., touch) at least one object icon 3960 in order to set at least one object to be moved to the main region 3810 in the list 3950.

Referring to FIG. 40, a visual guide is displayed, which makes it possible to set a target object to be moved to the main region 3810 among the multiple objects using a scroll bar 4010 (e.g., a vertical scroll bar or a horizontal scroll bar), which makes it possible to search for the target object based on scrolling. The electronic device may generate the scroll bar 4010, which makes it possible to scroll (e.g., to vertically scroll and/or horizontally scroll) multiple objects to be moved to the main region 3810 in a scroll manner based on the operation in which the user folds the display. The electronic device may provide the scroll bar 4010 through at least one of the top, bottom, left, right, and central regions of the main region 3810.

The electronic device may provide a visual guide, which makes it possible for the user to select an object to be moved to the main region 3810 (or to be displayed with the highest priority through the main region 3810) among the multiple objects by searching for multiple objects using the scroll bar 4010 in a scroll manner, to the user. The user may set an object to be moved to the main region 3810 by scrolling objects through input 4050 using the scroll bar 4010 and selecting one object among the multiple objects. The electronic device may provide, through the main region 3810, a previous or next object (or information about the object), which has not been visible in the main region 3810, by scrolling (e.g., vertically or horizontally moving) an object or information about the object displayed through the main region 3810 in response to the user's scrolling.

Referring to FIG. 41, a visual guide is displayed, which makes it possible to set a target object to be moved to the main region 3810 among the multiple objects based on multiple tiles 4150 (or pop-up windows, mini windows, or tile windows) corresponding to the number of target objects. The electronic device may identify multiple objects to be moved to the main region 3810 and/or the number thereof based on an operation in which the user folds the display, and may generate multiple windows 4110, 4120, and 4130 corresponding to the multiple identified objects. The electronic device may randomly arrange and provide the multiple windows 4110, 4120, and 4130 in a tile format at random positions in the main region 3810.

The multiple windows 4110, 4120, and 4130 may be arranged in order to not overlap each other, or may be arranged such that at least some of them overlap each other. The electronic device may provide a visual guide, which makes it possible to select an object to be moved to the main region 3810 (or to be displayed with the highest priority through the main region 3810), among the multiple objects based on the multiple tiles 4150, to the user. The user may select (e.g., touch) at least one window 4160 in the multiple tiles 4150 in order to set at least one object to be moved to the main region 3810.

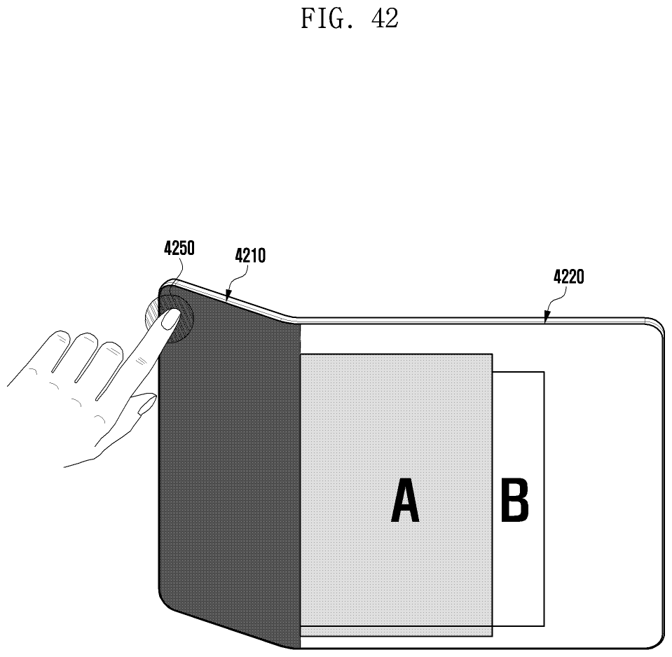

FIG. 42 illustrates canceling screen division in an electronic device according to an embodiment.

While providing a visual guide for screen division, the electronic device may cancel the screen division based on designated user input. FIG. 42 illustrates an example of canceling screen division based on reception of user input designated based on a target region 4210 and/or a main region 4220 from the user while providing a visual guide through the main region 4220.

Referring to FIG. 42, when designated user input 4250 is detected while a visual guide is provided through the main region 4220, the electronic device may cancel the screen division. The designated user input 4250 may include input (e.g., a touch input) through a region designated for cancellation of screen division in the target region 4210 or the main region 4220, input (e.g., drawing (e.g., drawing forming a closed curve), long touch, or double tap) designated for canceling screen division based on an arbitrary region of the target region 4210 or the main region 4220, or unfolding input of the display through the target region 4210. When user input 4250 is detected while a visual guide is being provided, the electronic device may cancel screen division, and may remove the displayed visual guide based on the main region 4220. The electronic device may restore an object to the original state thereof through the target region 4810 and the main region 4220, and may provide the restored object.

According to an embodiment, a method of operating an electronic device includes displaying one or more objects through a display; detecting an operation event in which the display is switched from a first state to a second state; monitoring a state change of the display based on the operation event; detecting a state in which the display is folded to a designated angle; dividing the display into a first display surface and a second display surface based on the state of being folded to the designated angle; and rearranging and displaying the one or more objects based on at least the first display surface or the second display surface.

The first display surface may include a display surface, which is folded about a folding axis in the display, and the second display surface may include a fixed display surface, which is not folded in the display.

Displaying the one or more objects may include displaying a target object of at least one of the displayed objects on the first display surface of the display based on the state of being folded to the designated angle; and displaying a remaining object other than the target object on the second display surface of the display.

Displaying the one or more objects may include determining, when a plurality of target objects related to the first display surface are present, priorities of the plurality of target objects; and determining an object to be displayed on the first display surface based on the priority.

Displaying the one or more objects may include identifying a target object to be included in the first display surface; and storing state information related to restoration of the identified target object.

The method may further include restoring the target object to an original state based on at least the first display surface and/or the second display surface based on the state information, and providing the restored target object when the display is switched to an unfolded state.

The method may further include detecting a trigger related to screen division in the state of being folded to the designated angle, and conducting an action for the trigger related to the screen division based on a designated trigger, wherein the designated trigger may include a designated angle different from the designated angle for executing the screen division or a designated user interaction.

The method may further include providing a guide related to the screen division at the designated angle; and executing the screen division based on the designated trigger in the state in which the guide is displayed.

The method may further include identifying the designated user interaction at the designated angle; and executing the screen division based on the identification of the user interaction.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. An electronic device, comprising:
a display;
a processor; and
a memory configured to store instructions that, when executed, cause the processor to:
display one or more objects through the display,
detect an operation event in which the display is switched from a first state to a second state,
monitor a state change of the display based on the operation event,
detect the display being folded to a designated angle,
divide the display into a first display surface and a second display surface based on the display being folded to the designated angle, and
rearrange and display the one or more objects based on at least one of the first display surface or the second display surface.

2. The electronic device of claim 1, wherein the first display surface comprises a display surface, which is folded about a folding axis in the display, and
wherein the second display surface comprises a fixed display surface, which is not folded in the display.

3. The electronic device of claim 1, wherein the instructions, when executed, further cause the processor to:
display a target object of at least one of the displayed one or more objects on the first display surface of the display based on the display being folded to the designated angle, and
display a remaining object other than the target object on the second display surface of the display.

4. The electronic device of claim 1, wherein the instructions, when executed, further cause the processor to:
determine, when a plurality of target objects related to the first display surface are present, priorities of the plurality of target objects, and
determine an object to be displayed on the first display surface based on the priorities.

5. The electronic device of claim 1, wherein the instructions, when executed, further cause the processor to:
identify a target object to be included in the first display surface, and
store, in the memory, state information related to restoration of the identified target object.

6. The electronic device of claim 5, wherein the instructions, when executed, further cause the processor to:
restore the target object to an original state based on at least one of the first display surface and the second display surface, based on the state information and provide the restored target object, when the display is switched to an unfolded state.

7. The electronic device of claim 1, wherein the instructions, when executed, further cause the processor to:
detect a trigger related to screen division at a first designated angle, and
conduct an action for the trigger related to the screen division based on a designated trigger.

8. The electronic device of clams 7, wherein the instructions, when executed, further cause the processor to:
provide a guide related to the screen division at the first designated angle, and
execute the screen division based on the designated trigger in a state in which the guide is displayed.

9. The electronic device of claim 7, wherein the designated trigger comprises at least one of a second designated angle, different from the first designated angle, for executing the screen division or a designated user interaction.

10. The electronic device of claim 1, wherein the instructions, when executed, further cause the processor to:
identify the designated user interaction at the designated angle, and
execute the screen division based on identification of the user interaction.

11. An electronic device, comprising:
a foldable display;
a processor; and
a memory configured to store instructions that, when executed, cause the processor to:
detect an operation event in which a state of the foldable display is changed, monitor a state change of the foldable display based on the operation event,
display at least one object including a first object included in a first target region for a first state in a range greater than or equal to a designated range, and rearrange and display a remaining object in a main region when there is the first state change, and
restore at least one object including a second object included in a second target region for a second state based on state information, and rearrange and display the at least one object through the second target region and the main region when there is the second state change.

12. A method of operating an electronic device, the method comprising:
displaying one or more objects through a display;
detecting an operation event in which the display is switched from a first state to a second state;
monitoring a state change of the display based on the operation event;
detecting the display being folded to a designated angle;
dividing the display into a first display surface and a second display surface based the display being folded to the designated angle; and
rearranging and displaying the one or more objects based on at least one of the first display surface or the second display surface,

13. The method of claim 12, wherein the first display surface includes a display surface, which is folded about a folding axis in the display, and
wherein the second display surface includes a fixed display surface, which is not folded in the display.

14. The method of claim 12, wherein displaying the one or more objects comprises:
displaying a target object of at least one of the displayed objects on the first display surface of the display based on the display being folded to the designated angle; and
displaying a remaining object other than the target object on the second display surface of the display.

15. The method of claim 12, wherein displaying the one or more objects comprises:
determining, when a plurality of target objects related to the first display surface are present, priorities of the plurality target objects; and
determining an object to be displayed on the first display surface based on the priorities.

16. The method of claim 12, wherein displaying the one or more objects comprises:
identifying a target object to be included in the first display surface; and
storing state information related to restoration of the identified target object.

17. The method of claim 16, further comprising restoring the target object to an original state based on at least one of the first display surface and the second display surface, based on the state information and providing the restored target object, when the display is switched to an unfolded state.

18. The method of claim 12, further comprising:
detecting a trigger related to screen division at a first designated angle; and
conducting an action for the trigger related to the screen division based on a designated trigger,
wherein the designated trigger includes a designated angle different from the designated angle for executing the screen division or a designated user interaction.

19. The method of claim 18, further comprising:
providing a guide related to the screen division at the designated angle; and
executing the screen division based on the designated trigger while the guide is displayed.

20. The method of claim 12, further comprising:
identifying the designated user interaction at the designated angle; and
executing the screen division based on identification of the user interaction.
